(19) United States
(12) Patent Application Publication
(10) Pub. No.: US 2005/0209850 A1
(43) Pub. Date: Sep. 22, 2005

(54) Voice retrieval system

(75) Inventors: Hiroshi Sugitani, Yokohama (JP); Hideo Ueno, Maebaru (JP); Toshihiro Ide, Yokohama (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/949,757

(22) Filed: Sep. 27, 2004

(30) Foreign Application Priority Data
Mar. 22, 2004 (JP) 2004-083160

(51) Int. Cl. G06F 7/00

(52) U.S. Cl. 704/242

(57) ABSTRACT

A system that extracts an attribute value from inputted voices, which was inputted by a user via a microphone, creates retrieval conditions including the attribute value, and performs retrieval according to the retrieval conditions, the system including: a unit, in the case where a user performs voice input via a microphone after the retrieval, extracting an attribute value from the inputted voices; a unit creating new retrieval conditions based on the attribute value and the retrieval conditions; and a unit performing retrieval with the new retrieval conditions.

### BACKGROUND OF THE INVENTION

The present invention relates to a technique for, in a system that performs retrieval according to attribute conditions uttered by a user, performing input of the attribute conditions for the retrieval efficiently.

Conventionally, in the Internet or the like, a service providing various kinds of information on cosmetics, cars, and the like has been known. This service causes a user to first select attribute values of products, on which the user desires to be provided with information, one by one, narrows down the products to products having the attribute values, and further causes the user to select products, on which the user desires to be provided with information, out of the narrowed-down products to thereby provide the user with information on the finally selected products.

A system for realizing such information provision service realizes a service that uses a voice recognition technique, with which a user can input plural attribute values at a time, to cause the user to select (input by voice) an attribute value of a target product first to thereby narrow down products to products having the attribute value, and then causes the user to select (input by voice) a product out of the narrowed-down products to thereby provide information on the product (narrowed-down information provision service according to attribute selection). Note that the attribute value is a characteristic value of an attribute inherent in a word. The attribute value is explained with a cosmetic as an example. The cosmetic has attributes, namely, a manufacturer, a brand, and an item and has attribute values, namely, AA company (specific company name) and the like for the manufacturer, BB (specific brand name) and the like for the brand, and a lipstick (specific item name) and the like for the item. By using the voice recognition technique in this way, the service improves input efficiency for a user.

A conventional technique will be explained briefly. FIG. 1 is a principle diagram of the conventional technique. Explained here as the conventional technique is a system that, in a PDA (personal digital assistant), realizes a cosmetics information provision application service using voice recognition for selecting one product out of tens of thousands of cosmetic items and displaying detailed information on the product.

Candidate data shown in FIG. 2 is registered in a candidate database (hereinafter referred to as candidate DB) 200. Attribute value data shown in FIG. 3 is registered in an attribute value database (hereinafter referred to as attribute value DB) 210.

An application control unit 100 refers to the candidate DB 200, registers attribute value recognition word data (same as the attribute value data shown in FIG. 3) in an attribute value recognition word database 220, and starts recognition of the attribute value data.

In addition, at that point, a candidate selection screen image shown in FIG. 4 is displayed on a display 20. This facilitate a user to input a manufacturer, a brand, and an item by voice.

It is assumed that a user, who has inspected a candidate selection screen shown in FIG. 4, utters, for example “meekakeiei, burandobuikei, kuchibeni (manufacturer KA, brand V_K, lipstick)” at a microphone 10 (S10). A voice recognition unit 110 recognizes (manufacturer KA, brand V_K, lipstick) from the inputted voice data and sends a result of this recognition to the application control unit 100 as attribute recognition data (S11).

Upon receiving the attribute recognition data, the application control unit 100 sends the received attribute recognition data to a candidate extracting unit 140 (S12). Upon receiving the attribute recognition data, the candidate extracting unit 140 refers to the candidate DB 200, extracts candidates coinciding with the attribute recognition data received earlier, creates candidate data, and sends the candidate data to the application control unit 100 (S13).

Upon receiving the candidate data, the application control unit 100 creates candidate recognition word data from the candidate data, registers the candidate recognition word data in a candidate recognition word database 240 (S14), and starts recognition of the candidate data.

In addition, at that point, a product selection screen image shown in FIG. 5 is displayed on the display 20. This facilitates the user to input the candidate data by voice.

It is assumed that a user who has inspected a product selection screen shown in FIG. 5 utters, for example, “shouhinhyakubuikei (product 100_V_K)” at the microphone 10 (S15). The voice recognition unit 110 recognizes the product 100_V_K from the inputted voice data and sends a result of this recognition to the application control unit 100 as attribute recognition data (S16).

The application control unit 100 refers to the candidate data received from the candidate extracting unit 140 in S13 earlier and displays a product detail screen image shown in FIG. 6 on the display 20.

Next, in the case where the user desires to change an attribute value to inspect other product information, the application control unit 100 causes the user to return to the product selection screen image of FIG. 5 and utter an attribute value again.

However, there are a method of writing an attribute value recognized here over an attribute value of the last time and a method of setting the recognized attribute value as it is regardless of the attribute value of the last time.

The respective methods will be explained below.

(Method of Writing a Recognized Attribute Value Over an Attribute Value of the Last Time)

(Case Where a User Desires to Inspect a Product of Mascara of a Manufacturer KA and a Brand V_K)

Since the “manufacturer KA” and the “brand V_K” have been inputted earlier, if the user utters “masukara (mascara)”, “mascara” is written over “lipstick” as indicated by a product selection screen image shown in FIG. 7.

However, in the case where the user desires to inspect a mascara of a manufacturer S, the user has to utter “meekaesu no masukara de burando wa kuria (mascara of manufacturer S, and clear the brand).” In this case, the user has to utter words indicating clearing of an attribute not used and is caused to perform extra voice input. Thus, the method is inconvenient for the user.

(Method of Setting a Recognized Attribute Value as it is)

(Case Where a User Desires to Inspect a Product of Mascara of a Manufacturer S)

If the user utters “meekaesu no masukara (mascara of manufacturer S)”, a manufacturer and an item are set as indicated in a product selection screen image shown in FIG. 8.

However, in the case where the user desires to inspect a mascara of the manufacturer KA and the brand V_K, the user has to utter “meekakeiee burandobuikei no masukara (a mascara of a manufacturer KA and a brand V_K)”, that is, the user has to utter the “meekakeiei (manufacturer KA)” and the “burandobuikei (brand V_K)” inputted earlier again. This makes the user feel that the user is performing useless input. Thus, the method is inconvenient for the user.

In addition, as a problem common to both the methods, in the case where attributes are in a dependence relation like a manufacturer and a brand of a cosmetic, if the user utters “meekaesu no burandobuikei (brand V_K of manufacturer S)” (actually, the brand V_K is a brand of the manufacturer KA), candidates are narrowed down regardless of the fact that the utterance lacks consistency. As a result, a corresponding product cannot be extracted. If the corresponding candidate is not obtained, the user feels stress, and serviceability falls.

Other than the above, there is a method of determining a confirmation response and the next operation based on a distance between attribute information inputted and decided once and attribute information inputted anew (e.g., see Patent document 1).
[Patent document 1] JP 2002-351492 A
[Patent document 2] JP 2002-189483 A

### SUMMARY OF THE INVENTION

In the conventional techniques, in (the method of writing a recognized attribute value over an attribute value of the last time), in the case where there is an attribute value not used, a user has to utter words such as “burando wa kuria (clear the brand)” and is caused to perform extra voice input, which takes time and trouble for the user. In addition, in (the method of setting a recognized attribute value as it is), a user has to utter an attribute value set last time again and is caused to perform extra voice input as in the former method.

It is an object of the invention to provide a technique for, in a system that performs retrieval according to attribute conditions uttered by a user, performing input of the attribute conditions for the retrieval efficiently without causing a user to perform extra voice input.

The present invention has been devised in order to solve the problem, and relates to a system that performs retrieval according to attribute conditions uttered by a user. The system includes: a microphone through which the user performs voice input; a voice recognition unit recognizing an attribute value from inputted voice data inputted via the microphone; an extracted attribute condition data creating unit creating extracted attribute condition data that is a correspondence relation between an attribute value recognized by the voice recognizing unit and an attribute; a saved attribute condition database in which saved attribute condition data, which is attribute conditions used for retrieval of the last time, is saved; an attribute condition judging unit creating attribute condition data, which is used for retrieval of this time, based on the extracted attribute condition data and the saved attribute condition data; a candidate database storing candidate data to be an object of retrieval; a candidate extracting unit retrieving candidate data from the candidate database based on the attribute condition data; and a display displaying a screen including a result of the retrieval.

According to the invention, attribute condition data, which is used for retrieval of this time, is created based on the extracted attribute condition data and the saved attribute condition data. As a result, it becomes possible to cause a user to perform input of attribute conditions for the retrieval efficiently without causing the user to perform extra voice input.

It is desirable that the system further includes, for example, a matching processing unit saving the attribute condition data in the saved attribute condition database.

In the system, for example, the attribute condition judging unit estimates an intention of the user to thereby judge whether the attribute conditions used for the retrieval of the last time are used continuously or cancelled and creates the attribute condition data to be used for the retrieval of this time.

Thus, it becomes possible to cause the user to perform input of attribute conditions for the retrieval efficiently without causing the user to perform extra voice input.

In the system, it is desirable that, for example, in the case where the attribute condition data includes a sub-attribute, the matching processing unit complement other attribute conditions with the sub-attribute.

With this, input efficiency can be improved.

In the system, for example, the matching processing unit may include a function for, in the case where the attribute condition data includes a sub-attribute, saving the sub-attribute in the saved attribute condition database, extracting uninputted attribute conditions that coincide with the attribute condition data and which the sub-attribute saved in the saved attribute condition database coincides with or is approximate to, and adding the attribute conditions.

The invention can also be specified as described below.

A system that extracts an attribute value from inputted voices, which was inputted by a user via a microphone, creates retrieval conditions including the attribute value, and performs retrieval according to the retrieval conditions, the system including: a unit, in the case where a user performs voice input via a microphone after the retrieval, extracting an attribute value from the inputted voices; a unit creating new retrieval conditions based on the attribute value and the retrieval conditions; and a unit performing retrieval with the new retrieval conditions.

The invention can also be specified as an invention of a method as described below.

A method of extracting an attribute value from inputted voices, which was inputted by a user via a microphone, creating retrieval conditions including the attribute value, and performing retrieval according to the retrieval conditions, the method including the steps of: in the case where a user performs voice input via a microphone after the retrieval, extracting an attribute value from the inputted voices; creating new retrieval conditions based on the attribute value and the retrieval conditions; and performing retrieval with the new retrieval conditions.

Next, units of the invention will be explained with reference to a principle diagram of the invention shown in FIG. 9. Note that the same components as those in the conventional example are denoted by identical reference numerals and signs.

First, a schematic structure of the invention will be explained. Reference numeral 10 denotes a microphone that receives voice input of a user. Reference numeral 20 denotes a display. Reference numeral 100 denotes an application control unit controlling an application, which includes a function of the extracted attribute condition data creating unit 100a as described later. In other words, the application control unit 100 functions also as the extracted attribute condition data creating unit of the invention.

Reference numeral 110 denotes a voice recognition unit applying voice recognition to voice input data inputted from the microphone. Reference numeral 120 denotes an attribute condition judging unit setting an attribute value based on contents uttered by the user. Reference numeral 130 denotes a matching processing unit confirming consistency of the attribute value and correcting the attribute value. Reference numeral 140 denotes a candidate extracting unit referring to the candidate database 200 and extracting candidates from the attribute value. Reference numeral 150 denotes a screen display unit displaying a screen on the display 20. Reference numeral 200 denotes a candidate database in which candidate data is accumulated. Reference numeral 210 denotes an attribute value database in which attribute value data is accumulated. Reference numeral 220 denotes an attribute value recognition word database in which attribute value recognition word data is accumulated. Reference numeral 230 denotes a saved attribute condition database in which attribute value data set last time is accumulated. Reference numeral 240 denotes a candidate recognition word database in which candidate recognition word data is accumulated.

Next, actions of the invention will be explained with reference to FIG. 9.

When an application is started, the application control unit 100 refers to the attribute value database 210 and creates attribute recognition word data (S20) and registers the attribute value recognition word data in the attribute value recognition word database 220 (S21) in accordance with the application control flow shown in FIG. 10. In addition, the application control unit 100 sends an attribute recognition start message to the voice recognition unit 110 (S22) and sends a screen display message to the screen display unit 150 (S23).

The voice recognition unit 110, which has received the attribute recognition start message, starts recognition of attributes with the attribute value recognition word database 220 as a recognition word.

The screen display unit 150, which has received the screen display message, displays an attribute recognition screen image on the display 20.

When a user utters an attribute value, voice input data is sent to the voice recognition unit 10 from the microphone 10.

The voice recognition unit 110, which has received the voice input data, performs voice recognition and sends attribute recognition data to the application control unit 100.

The application control unit 100, which has received the attribute recognition data, refers to the attribute value DB 210 and acquires an attribute value of the attribute recognition data (S24) and creates extracted attribute condition data (S25) in accordance with the application control flow in FIG. 10. Subsequently, the application control unit 100 sends the created extracted attribute condition data to the attribute condition judging unit 120 (S26).

The attribute condition judging unit 120, which has received the extracted attribute condition data, confirms whether saved attribute condition data is saved in the saved attribute condition database 230 (S27) in accordance with an attribute setting judging unit flow in FIG. 11.

If the saved attribute condition data is not saved (No in S27), the attribute condition judging unit 120 creates attribute condition data using the extracted attribute condition data as it is (S30).

If the saved attribute condition data is saved (Yes in S27), the attribute condition judging unit 120 acquires the saved attribute condition data (S28), and performs attribute setting processing (S29) and creates attribute condition data (S30) in accordance with an attribute setting processing flow in FIG. 12.

Next, the attribute setting processing will be explained with reference to FIG. 12. If there is an attribute having a sub-attribute in the extracted attribute condition data (Yes in S290) and there are other attributes therein as well (Yes in S2901), the attribute condition judging unit 120 uses the attribute having the sub-attribute in the extracted attribute condition data and attribute values of the other attributes to create attribute condition data (S2902). In addition, if there is an attribute having a sub-attribute in the extracted attribute condition data (Yes in S2900) and there are no other attributes therein (No in S2901), the attribute condition judging unit 120 confirms whether attribute values of the attributes having the sub-attributes in the extracted attribute condition data and the saved attribute condition data are the same (S2903). If the attribute values are the same (Yes in S2903), the attribute condition judging unit 120 uses the attribute value of the attribute having the sub-attribute in the extracted attribute condition data to create attribute condition data (S2904). If the attribute values are not the same (No in S2903), the attribute condition judging unit 120 creates attribute condition data in a form of writing the attribute value of the attribute having the sub-attribute in the extracted attribute condition data over an attribute value of an attribute other than the attribute having the sub-attribute in the saved attribute condition data (S2905).

In addition, if there is no attribute having a sub-attribute in the extracted attribute condition data (No in S2900) and if some of the attribute values of the attributes in the extracted attribute condition data and the saved attribute condition data are the same (Yes in S2906), the attribute condition judging unit 120 uses the attribute value of the attribute in the extracted attribute condition data to create attribute condition data (S2907).

In addition, if there is no attribute having a sub-attribute in the extracted attribute condition data, and none of the attribute values of the attributes in the extracted attribute condition data and the saved attribute condition data are the same, the attribute condition judging unit 120 creates attribute condition data in a form of writing the extracted attribute condition data over the saved attribute condition data (S2908). The attribute condition judging unit 120 sends the created attribute condition data to the application control unit 100 (S31).

The application control unit 100, which has received the attribute condition data, sends the attribute condition data to the matching processing unit 130 (S32) in accordance with the application control flow in FIG. 10. The matching processing unit 130 confirms whether the attribute condition data has an attribute having a sub-attribute (S33) in accordance with the matching processing unit flow in FIG. 13.

If the attribute condition data has an attribute having a sub-attribute (Yes in S33), the matching processing unit 130 refers to the attribute value DB 210 and acquires an attribute value of the sub-attribute of the attribute (S34). The matching processing unit 130 creates matched attribute condition data in a form of writing the acquired attribute value of the sub-attribute over the attribute condition data (S35). If the attribute condition data does not have an attribute having a sub-attribute, the matching processing unit 130 uses the attribute condition data as it is to create matched attribute condition data.

The matching processing unit 130 sends the created matched attribute condition data to the application control unit 100 (S37).

The application control unit 100, which has received the matched attribute condition data, sends the matched attribute condition data to the candidate extracting unit 140 in accordance with the application control flow in FIG. 10 (S38).

The candidate extracting unit 140, which has received matched attribute condition data, refers to the candidate DB 200 and extracts candidate data matching the attribute conditions of the matched attribute condition data to create candidate data.

The candidate extracting unit 140 sends the created candidate data to the application control unit 100. The application control unit 100, which has received the candidate data, creates candidate recognition word data from the candidate data (S39) and registers the candidate recognition word data in the candidate recognition word database 240 (S40) in accordance with the application control flow in FIG. 10. After the completion of the registration, the application control unit 100 sends a candidate recognition start message to the voice recognition unit 110. In addition, the application control unit 100 sends a screen display message to the screen display unit 150 (S41).

The voice recognition unit 110, which has received the candidate recognition start message, starts candidate recognition. The screen display unit 150, which has received the candidate display message, displays a candidate recognition screen image on the display 20. When the user utters a candidate, voice input data is sent to the voice recognition unit 110 from the microphone 10. The voice recognition unit 110, which has received the voice input data, performs voice recognition and sends candidate recognition data to the application control unit 100.

The application control unit 100, which has received the candidate recognition data, acquires corresponding one candidate data from the candidate data received from the candidate extracting unit 140 earlier (S42) and sends the acquired candidate data to the screen display unit 150 (S43) in accordance with the application control flow in FIG. 10. The screen display unit 150, which has received the candidate data, displays detailed information on a candidate on the display 20.

Next, processing of the matching processing unit 130 will be explained with reference to FIG. 14.

The attribute condition data is sent to the matching processing unit 130 from the application control unit 100. The matching processing unit 130, which has received the attribute condition data, confirms whether the attribute condition data has an attribute having a sub-attribute (S50). If the attribute condition data has the attribute having the sub-attribute (Yes in S50), the matching processing unit 130 refers to the attribute value DB 210 and acquires an attribute value of the attribute having the sub-attribute (S51). When the matching processing unit 130 acquires the attribute value, the matching processing unit 130 creates consistent attribute condition data in a form of writing the acquired attribute value over the attribute condition data (S52).

In addition, if the attribute condition data does not have an attribute having a sub-attribute (No in S50), the matching processing unit 130 confirms whether an attribute having a sub-attribute is present in the saved attribute condition data (S55). If an attribute having a sub-attribute is not present in the saved attribute condition data (No in S55), the matching processing unit 130 creates the attribute condition data directly as consistent attribute condition data.

In addition, if an attribute having a sub-attribute is present in the saved attribute condition data (Yes in S55), the matching processing unit 130 refers to the attribute value DB 210 and retrieves attribute values coinciding with attribute values of all attributes included in the attribute condition data (S56). If there is no attribute value coinciding with the attribute values of all the attributes (No in S57), the matching processing unit 130 creates the attribute condition data directly as consistent attribute condition data. If there are attribute values coinciding with the attribute values of all the attributes (Yes in S57), the matching processing unit 130 refers to the attribute value DB 210 and retrieves an attribute value having both the attribute value of the attribute included in the attribute condition data and the attribute value of the sub-attribute of the attribute having the sub-attribute in the saved attribute condition data (S58). If there is no corresponding attribute value (No in S59), the matching processing unit 130 changes the attribute value of the sub-attribute of the attribute having the sub-attribute and retrieves an attribute value having both the attribute values again (S60).

If there is a corresponding attribute value (Yes in S59), the matching processing unit 130 extracts an attribute value of a sub-attribute of an attribute having a sub-attribute of the corresponding attribute value and creates matched attribute condition data in a form of writing the attribute value of the sub-attribute over the attribute data (S61). When the matched attribute condition data is created, the matching processing unit 130 sends the matched attribute condition data to the application control unit 100 (S54).

According to the invention, an attribute value, which a user desires to select, is estimated based on extracted attribute condition data including an attribute value obtained from uttered contents (voice input) of the user and saved attribute condition data, which is setting information of an attribute value of the last time, to create attribute condition data used for retrieval of this time. Therefore, an attribute, which the user desires to set, can be set without causing the user to utter an unnecessary attribute value such as “burando wo kuria (clear the brand)” and without causing the user to input contents uttered last time again by voice. Thus, it is possible to cause the user to perform setting of an attribute value which saves the user trouble and time and which is convenient.

In addition, for attributes in a dependence relation such as a manufacturer and a brand of cosmetics, consistency can be attained automatically. Thus, a situation can be eliminated, in which consistency of attribute values, which a user is about to set, is not attained and candidates are not narrowed down. Therefore, the user can use the voice input service comfortably.

Further, when a manufacturer T and a car model C_T are set as attributes last time, and a user utters “meekaenu (manufacturer N)” next, car models in the same rank as that of the car model C_T of the manufacturer T can be extracted out of car models of a manufacturer N. This allows the user to inspect information on car models in the same rank even if the user does not know the car models of the manufacturer N. Thus, serviceability can be improved.

### DESCRIPTION OF THE DRAWINGS

FIG. 1 is a principle diagram of a conventional technique of the invention.

FIG. 2 is an example of candidate data accumulated in a candidate database of the conventional technique of the invention.

FIG. 3 is an example of attribute value data accumulated in an attribute value database of the conventional technique of the invention.

FIG. 4 is an example of a product selection screen image of the conventional technique of the invention.

FIG. 5 is an example of a product selection screen image of the conventional technique of the invention.

FIG. 6 is an example of a product detail display screen image of the conventional technique of the invention.

FIG. 7 is an example of a product selection screen image of the conventional technique of the invention.

FIG. 8 is an example of a product selection screen image of the conventional technique of the invention.

FIG. 9 is a principle diagram of the invention.

FIG. 10 is a diagram for explaining processing by an application control unit in the invention.

FIG. 11 is a diagram for explaining processing by an attribute setting judging unit in the invention.

FIG. 12 is a diagram for explaining attribute setting processing in the invention.

FIG. 13 is a diagram for explaining processing by a matching processing unit in the invention.

FIG. 14 is a diagram for explaining processing by the matching processing unit in the invention.

FIG. 15 is a principle diagram of an embodiment to which the invention is applied.

FIG. 16 is an example of product data of a product database in a first embodiment.

FIG. 17 is an example of attribute value data of an attribute value database in the first embodiment.

FIG. 18 is a flowchart for explaining processing by an application control unit in the first embodiment.

FIG. 19 is an example of attribute value recognition word data in the first embodiment.

FIG. 20 is an example of a product selection screen image in the first embodiment.

FIG. 21 is an example of attribute recognition data in the first embodiment.

FIG. 22 is an example of extracted attribute condition data in the first embodiment.

FIG. 23 is a flowchart for explaining processing by an attribute setting judging unit in the first embodiment.

FIG. 24 is a flowchart for explaining attribute setting processing in the first embodiment.

FIG. 25 is an example of attribute condition data in the first embodiment.

FIG. 26 is a flowchart for explaining processing by a matching processing unit in the first embodiment.

FIG. 27 is an example of matched attribute condition data in the first embodiment.

FIG. 28 is an example of product candidate data in the first embodiment.

FIG. 29 is an example of product recognition word data in the first embodiment.

FIG. 30 is an example of a product selection screen image in the first embodiment.

FIG. 31 is an example of product recognition data in the first embodiment.

FIG. 32 is an example of product candidate data in the first embodiment.

FIG. 33 is an example of a product detail display screen image in the first embodiment.

FIG. 34 is an example of a product selection screen image in the first embodiment.

FIG. 35A is an example of consistent attribute data creation in the first embodiment.

FIG. 35B is an example of consistent attribute data creation in the first embodiment.

FIG. 35C is an example of consistent attribute data creation in the first embodiment.

FIG. 36A is an example of consistent attribute data creation in the first embodiment.

FIG. 36B is an example of consistent attribute data creation in the first embodiment.

FIG. 36C is an example of consistent attribute data creation in the first embodiment.

FIG. 37 is an example of product candidate data of a product candidate database in the first embodiment.

FIG. 38 is an example of attribute value data of an attribute value database in a second embodiment.

FIG. 39 is an example of a product selection screen image in the second embodiment.

FIG. 40 is an example of attribute recognition data in the second embodiment.

FIG. 41 is an example of extracted attribute condition data in the second embodiment.

FIG. 42 is a flowchart for explaining processing by a matching processing unit in the second embodiment.

FIG. 43a is an example of attribute condition data in the second embodiment.

FIG. 43b is an example of matched attribute condition data in the second embodiment.

FIG. 43c is an example of saved attribute condition data in the second embodiment.

FIG. 44 is an example of a product selection screen image in the second embodiment.

FIG. 45 is an example of a product detail display screen image in the second embodiment.

FIG. 46 is an example of attribute recognition data in the second embodiment.

FIG. 47 is an example of extracted attribute condition data in the second embodiment.

FIG. 48 is an example of attribute condition data in the second embodiment.

FIG. 49 is an example of matched attribute condition data in the second embodiment.

FIG. 50 is an example of saved attribute condition data in the second embodiment.

FIG. 51 is a flowchart for explaining attribute setting processing in the second embodiment.

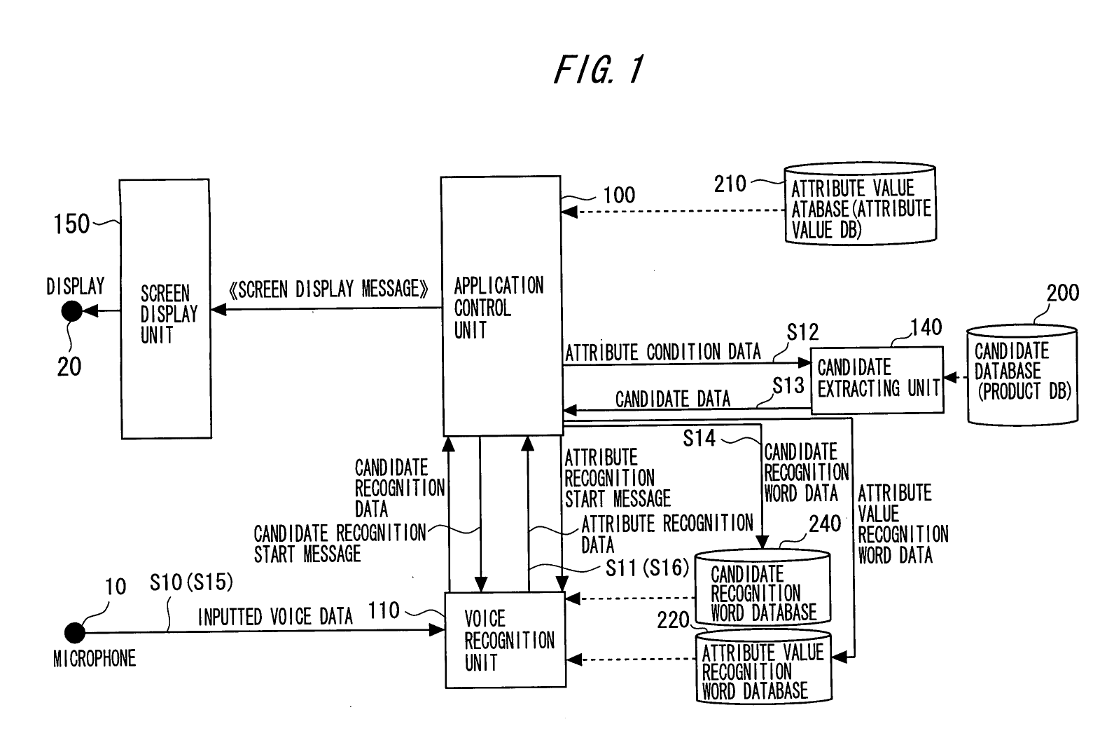

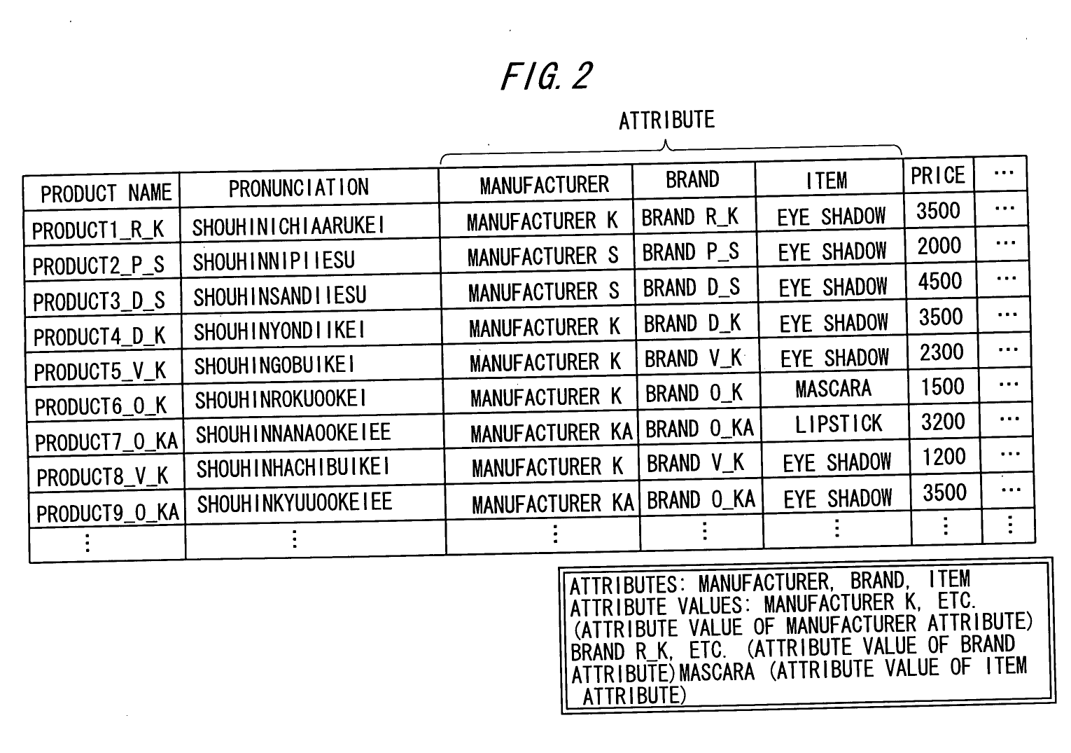

### DETAILED DESCRIPTION OF THE INVENTION

A cosmetics information provision application (cosmetics information retrieval system), which is a first embodiment of the invention, will be hereinafter explained with reference to the drawings.

(Cosmetics Information Provision Application)

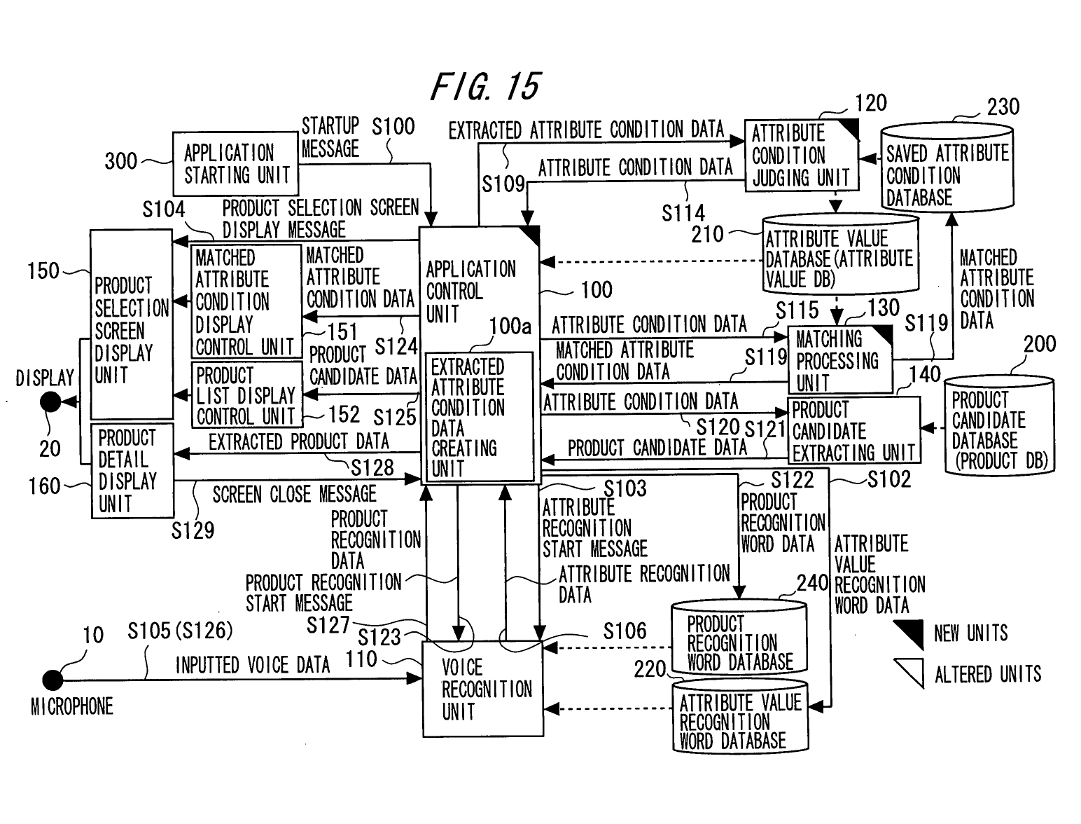

FIG. 15 is a principle diagram of the cosmetics information provision application (cosmetics information retrieval system) to which the invention is applied.

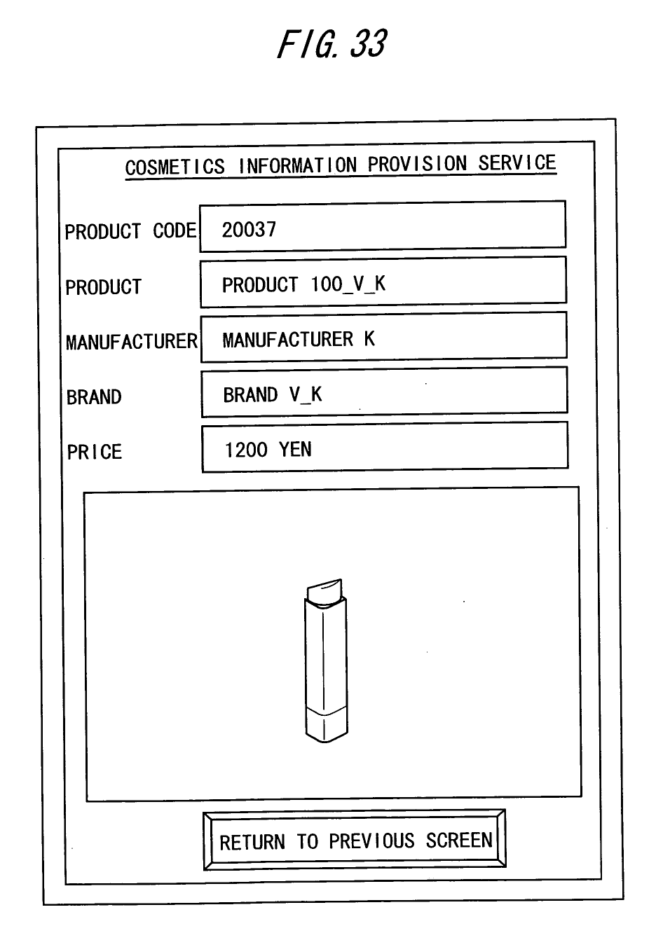

The cosmetics information provision application is realized by a portable information terminal such as a PDA (Personal Digital Assistance) reading and executing a predetermined program. The cosmetics information provision application finally selects one cosmetic (product) out of tens of thousands of items of cosmetics and displays information (detailed information) on the finally selected cosmetics as a product detail display screen (see FIG. 33).

(Schematic System Structure of the Cosmetics Information Provision Application)

As shown in FIG. 15, the cosmetics information provision application includes an application control unit 100, a voice recognition unit 110, an attribute condition judging unit 120, a matching processing unit 130, a product candidate extracting unit 140, a product selection screen display unit 150, a matched attribute condition display control unit 151, a product list display control unit 152, a product detail display unit 150, a product candidate database (hereinafter referred to as product candidate DB) 200, an attribute value database (hereinafter referred to as attribute value DB) 210, an attribute value recognition word database (hereinafter referred to as attribute value recognition word DB) 220, a saved attribute condition database (hereinafter referred to as saved attribute condition DB) 230, a product recognition word database (hereinafter referred to as product recognition word DB) 240, and an application starting unit 300.

Those functions are realized by an information processing terminal such as a PDA Reading and executing a predetermined program. Note that the databases such as the product candidate DB 200 may be provided externally such that a user accesses the external databases to acquire data as required.

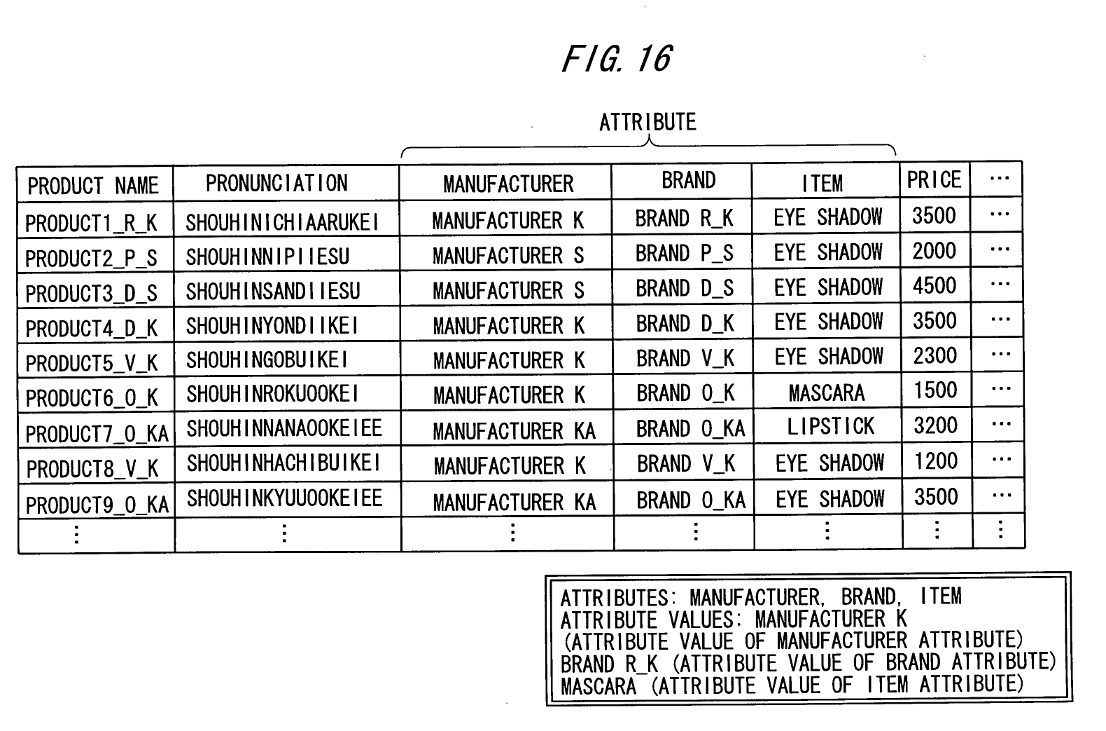

Product candidate data (candidate data of tens of thousands of items of cosmetics) are accumulated (stored) in the product candidate DB 200. FIG. 16 shows an example of the product candidate data. A group of data arranged in a row in the figure indicates one product candidate data. The product candidate data is constituted by items (a product name, attributes (a manufacturer, a brand, and an item), a price, etc.) constituting a product detail display screen (see FIG. 33) and items (pronunciation, etc.) used as a recognition word by the voice recognition unit 110.

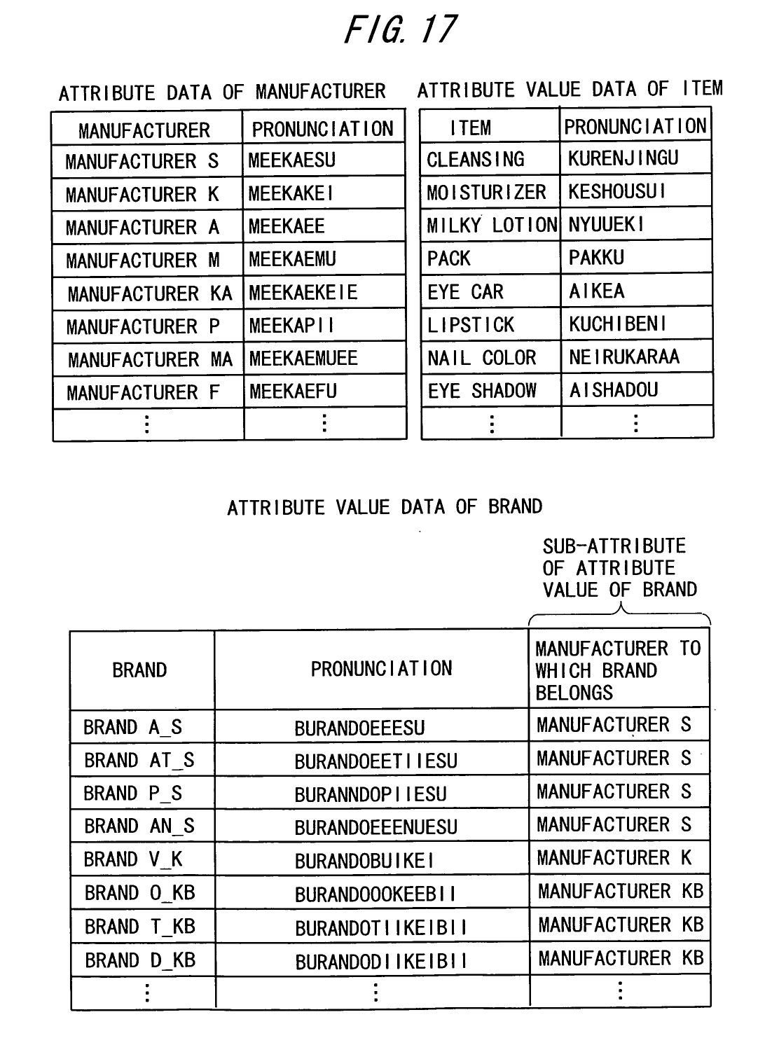

A correspondence relation between attribute values and pronunciations used as recognition words by the voice recognition unit 110 (attribute value data) is accumulated (stored) in the attribute value DB 210. FIG. 17 shows an example of the attribute value data. The attribute value data is provided for each attribute (a manufacturer, a brand, or an item). The attribute data for the brand further includes a correspondence relation between an attribute value and a sub-attribute of the attribute value, a manufacturer to which the brand belongs (see FIG. 17). Note that the attribute value data covers all the attribute values included in the attributes of the product candidate data (see FIG. 16).

Functions of the other units and contents of the databases will be clarified by the following explanation of operations and the like.

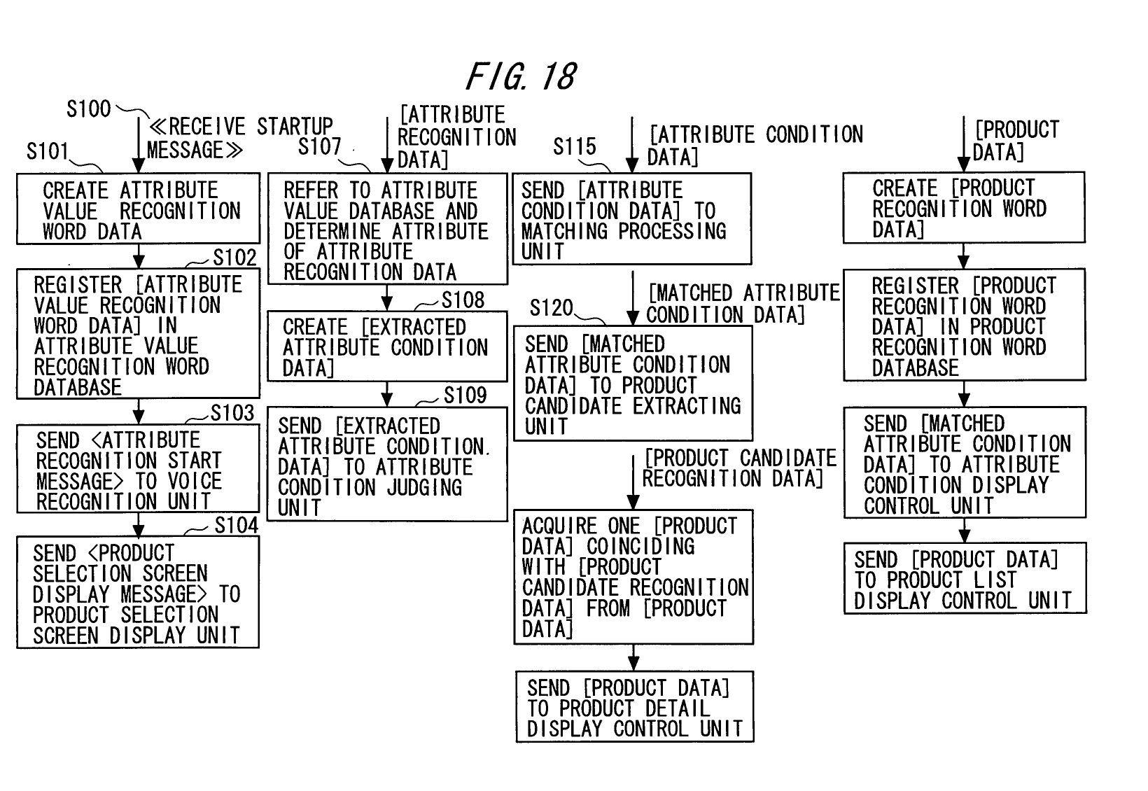

Next, an operation of the cosmetics information provision application (cosmetics information retrieval system) with the above-mentioned structure will be explained with reference to the drawings. FIGS. 15 and 18 are diagrams for explaining the operation of the cosmetics information provision application (cosmetics information retrieval system).

(Startup of the Cosmetics Information Provision Application)

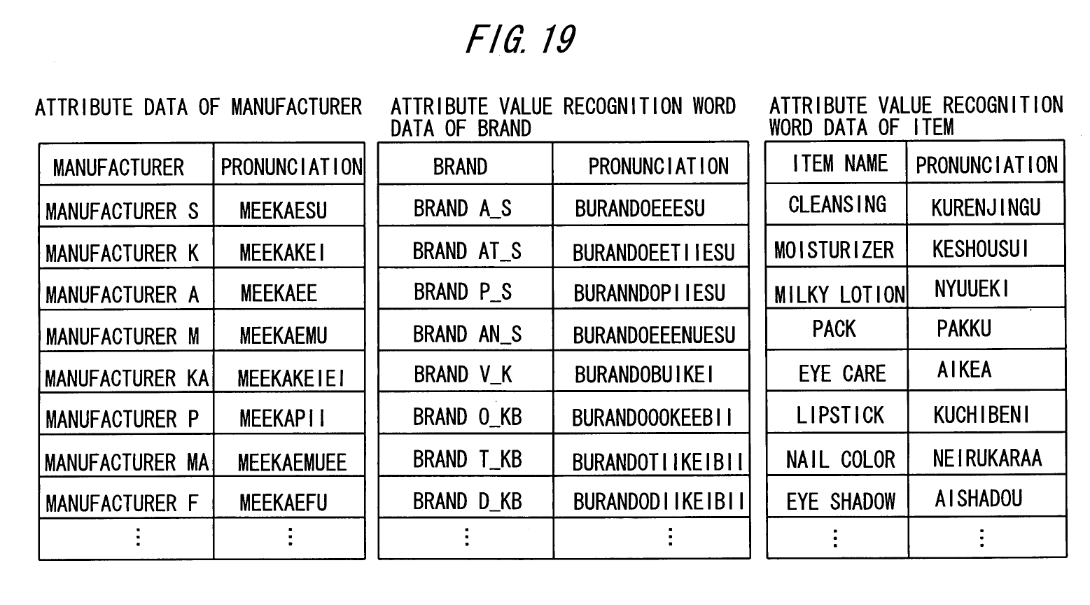

As shown in FIGS. 15 and 18, when a user starts the cosmetics information provision application, the application starting unit 300 sends a startup message to the application control unit 100. Upon receiving the startup message (S100), the application processing unit 100 creates a correspondence relation between an attribute value and a pronunciation used as a recognition word by the voice recognition unit 110 (attribute value recognition word data) for each attribute (S101). FIG. 19 shows an example of the attribute value recognition word data. The attribute value recognition word data is created with reference to the attribute value DB 210 (attribute value data). The application processing unit 100 registers the created attribute value recognition word data in the attribute value recognition word DB 220 (S102).

When the registration is completed, the application control unit 100 sends an attribute recognition start message to the voice recognition unit 110 (S103) and further sends a product selection screen display message to the product selection screen display unit 150 (S104).

Upon receiving the attribute recognition start message, the voice recognition unit 110 starts voice recognition. The voice recognition is executed with the attribute recognition word data (see FIG. 19) registered in the attribute recognition word DB 220 earlier as a recognition word. The voice recognition makes it possible to obtain (extract) an attribute value from contents uttered by the user.

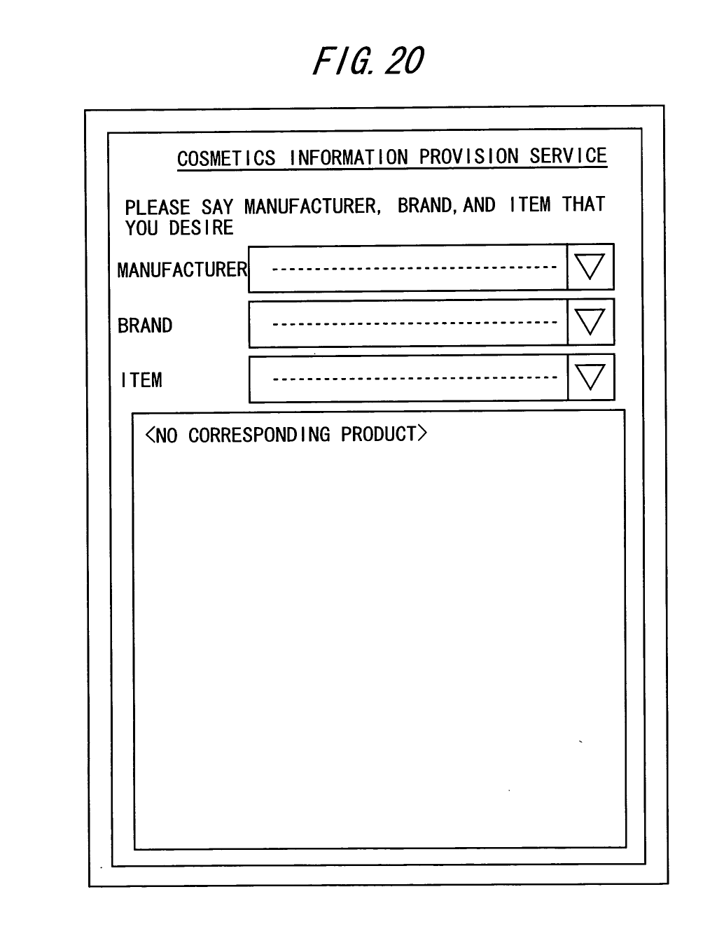

On the other hand, upon receiving the product selection screen display message, the product selection screen display unit 150 displays a product selection screen image (see FIG. 20) on the display 20. The product selection screen image includes an indication facilitating the user to utter words (voice input) concerning the attributes (a manufacturer, a brand, and an item) such as “gokibou no meeka, burando, aitemu wo osshattekudasai (please say a manufacturer, a brand, an item that you desire).” (Utterance)

The user, who has inspected this product selection screen image, utters a desired attribute value at the microphone 10. Here, it is assumed that the user has uttered “meekakeiee no burandobuikei no kuchibeni (lipstick of brand V_K of manufacturer KA).” The manufacturer KA is an attribute value of a manufacturer attribute, the brand V_K is an attribute value of a brand attribute, and the lipstick is an attribute value of an item attribute

(Voice Recognition of an Attribute)

This is processing for, in the case where a user has performed voice input via the microphone 10, extracting an attribute value (attribute recognition data) from the inputted voices.

Uttered contents (inputted voice data) of the user inputted via the microphone 10 are sent to the voice recognition unit 110 (S105). Upon receiving the inputted voice data, the voice recognition unit 110 applies publicly-known voice recognition (processing) to the inputted voice data. More specifically, the voice recognition unit 110 executes voice recognition with the attribute recognition word data (see FIG. 19) registered in the attribute recognition word DB 220 earlier as a recognition word.

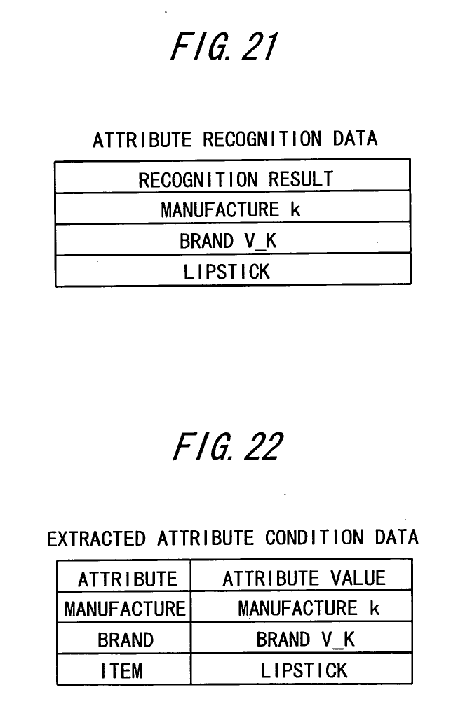

Consequently, the voice recognition unit 110 recognizes (extracts) attribute values (here, the manufacturer KA as a manufacturer attribute value, the brand V_K as a brand attribute value, and the lipstick as an item attribute value) from the uttered contents of the user (here, “meekakeiee no burandobuikei no kuchibeni (lipstick of brand V_K of manufacturer KA)”). FIG. 21 shows an example of a result of the recognition. The voice recognition unit 110 sends this recognition result (the manufacturer KA, the brand V_K, and the lipstick) to the application control unit 100 as attribute recognition data (S106). Note that, here, the voice recognition unit 110 uses a voice recognition engine that is capable of recognizing plural words from contents uttered by the user once (a series of uttered contents). This is a publicly-known technique.

(Attribute Condition Judgment)

As shown in FIG. 18, upon receiving the attribute recognition data (here, the manufacturer KA, the brand V_K, the lipstick), the application control unit 100 creates a correspondence relation (extracted attribute condition data) between the respective attribute values (here, the manufacturer KA, the brand V_K, the lipstick) constituting the received attribute recognition data and the attributes (the manufacturer, the brand, and the item) (S107, S108). FIG. 22 shows an example of the extracted attribute condition data. The extracted attribute condition data is created by determining the attributes corresponding to the respective attribute values with reference to the attribute value DB 210 (see FIG. 17) (S107, S108). The application control unit 100 sends the created extracted attribute condition data (see FIG. 22) to the attribute condition judging unit 120 (S109).

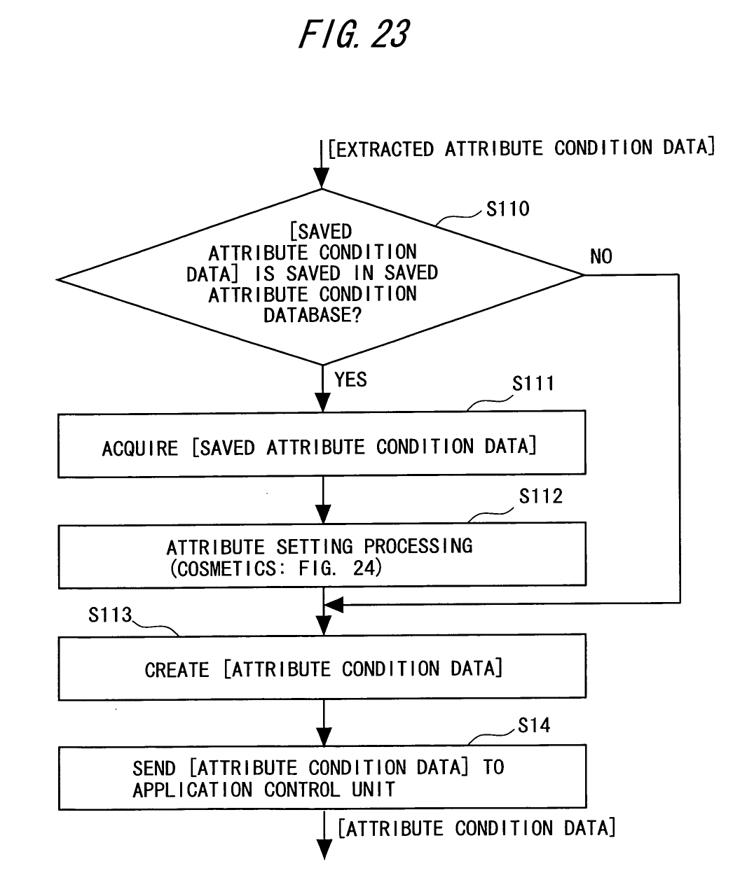

As shown in FIG. 23, upon receiving the extracted attribute condition data, the attribute condition judging unit 120 creates retrieval conditions (attribute condition data) of the product candidate DB 200. If attribute condition data (also referred to as saved attribute condition data) used at the time when products were narrowed down (products were retrieved) last time is registered in the saved attribute condition DB 230, the attribute condition data is created by taking into account the saved attribute condition data.

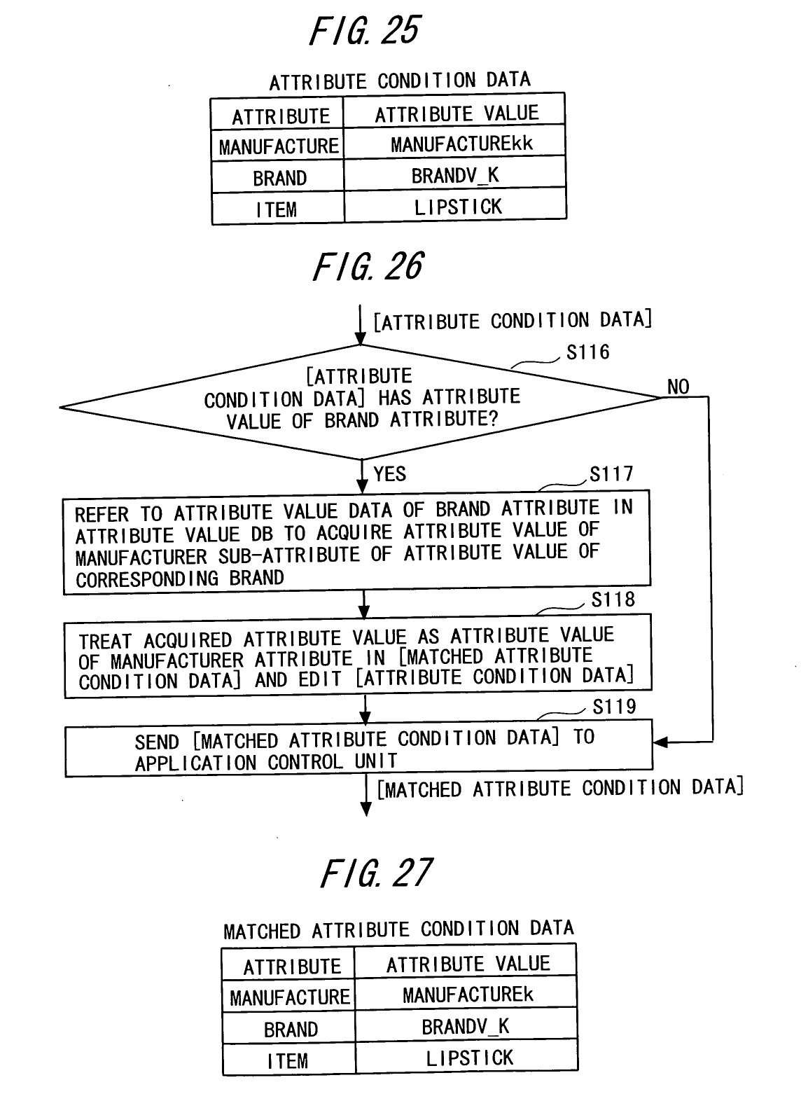

In order to create the retrieval conditions, first, the attribute condition judging unit 120 judges whether the saved attribute condition data is registered in the saved attribute condition DB 230 (S110). Here, since the user has only uttered “meekakeiee no burandobuikei no kuchibeni (lipstick of brand V_K of manufacturer KA)”, the saved attribute condition data is not saved in the saved attribute condition DB 230. Therefore, the attribute condition judging unit 120 judges that the saved attribute condition data is not registered (No in S110) and creates attribute condition data that includes the attribute values (the manufacturer KA, the brand V_K, and the lipstick) included in the extracted attribute condition data received earlier directly as attribute values (S113). FIG. 25 shows an example of the attribute condition data. The attribute condition judging unit 120 sends the created attribute condition data to the application control unit 100 (S114). Note that, processing (S111 to S114) in the case where it is judged that the saved attribute condition data is registered (Yes in S110) as a result of the judgment in S110 will be described later.

(Matching Processing)

As shown in FIG. 15, upon receiving the attribute condition data from the attribute condition judging unit 120, the application control unit 100 sends the received attribute condition data to the matching processing unit 130 (S115). As shown in FIG. 26, upon receiving the attribute condition data, the matching processing unit 130 judges whether the received attribute condition data includes an attribute value of a brand attribute (S116). Here, since the attribute condition data has an attribute value of a brand attribute (the brand V_K) (Yes in S117), the matching processing unit 130 refers to attribute value data of a brand attribute in the attribute value DB 210 (see FIG. 17) and acquires an attribute value (the manufacturer KA) of a manufacturer sub-attribute (a manufacturer to which the brand belongs) corresponding to the attribute value of the brand attribute (the brand V_K) (S117).

The matching processing unit 130 compares the acquired attribute value (the manufacturer KA) of the manufacturer sub-attribute and the attribute value (manufacturer KA) of the manufacturer attribute of the attribute condition data received earlier. In this case, both the attribute values coincide with each other, that is, the manufacturer KA is correct as the attribute value of the manufacturer attribute. In this case, the matching processing unit 130 treats the attribute condition data received earlier as matched attribute condition data (S118). FIG. 27 shows an example of the matched attribute condition data. Note that processing in the case where both the attribute values do not coincide with each other will be described later.

As described above, the matching processing unit 130 obtains the matched attribute condition data (equivalent to retrieval conditions of the invention) The matching processing unit 130 sends the matched attribute condition data to the application control unit 100 (S119). In addition, the matching processing unit 130 registers (saves) the matched attribute condition data in the saved attribute condition DB 230 as saved attribute condition data (S119).

Upon receiving the matched attribute condition data from the matching processing unit 130, the application control unit 100 sends the received matched attribute condition data to the product candidate extracting unit 140 (S120). (Product candidate extraction).

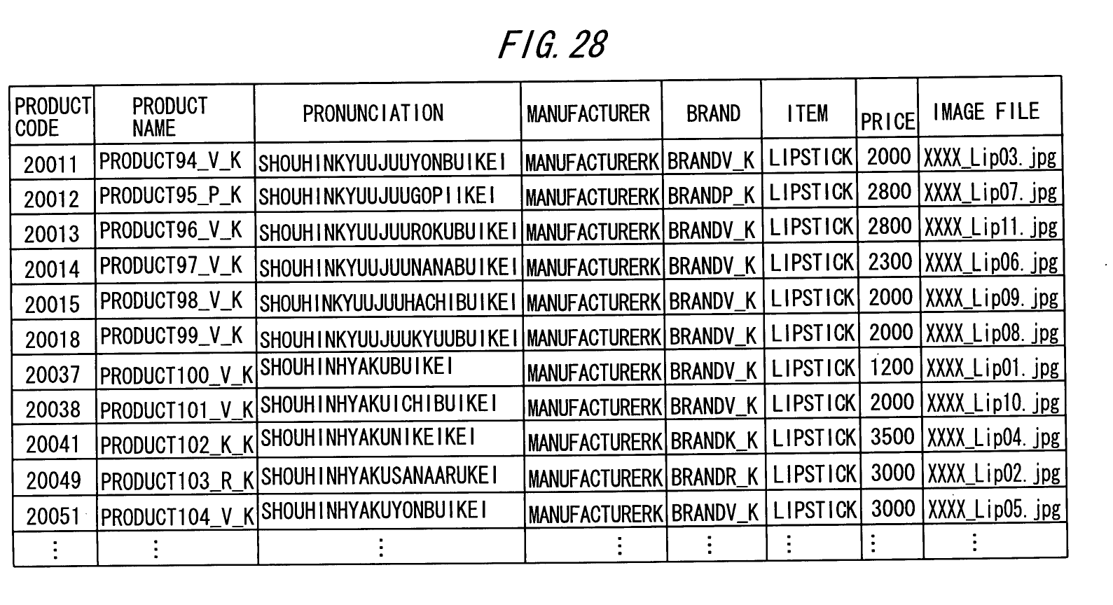

Upon receiving the matched attribute condition data, the product candidate extracting unit 140 acquires (retrieves) product candidate data corresponding to the matched attribute condition data (see FIG. 27) from the product DB 200 (see FIG. 16) and sends the product candidate data to the application control unit 100 (S121). FIG. 28 shows an example of the product candidate data.

(Start Voice Recognition for a Product)

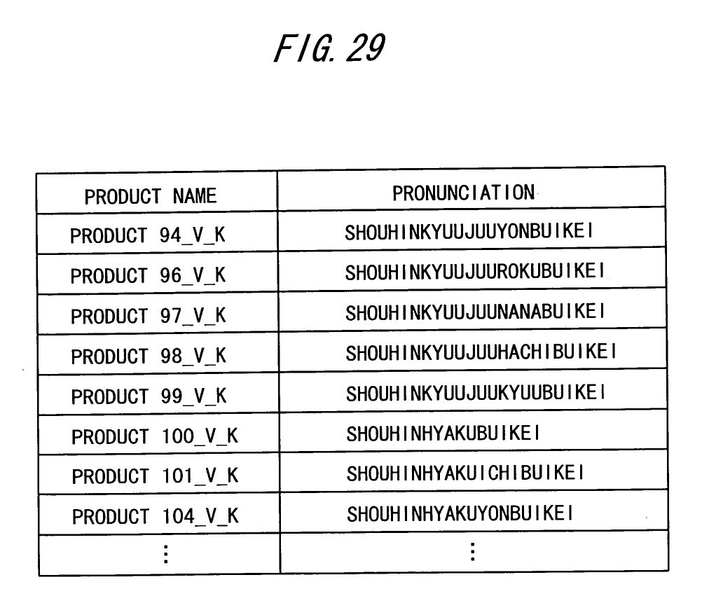

Upon receiving the product candidate data (see FIG. 28), the application control unit 100 creates a correspondence relation between product names and pronunciations used as recognition words by the voice recognition unit 110 (product recognition word data). FIG. 29 shows an example of the product recognition word data. The product recognition word data is created by extracting a product name part and a pronunciation part from the product candidate data (see FIG. 28) received earlier. The application control unit 100 registers the created product recognition word data (see FIG. 29) in the product recognition word DB 240 (S122).

When the registration is completed, the application control unit 100 sends a product recognition start message to the voice recognition unit 110 (S123). In addition, the application control unit 100 sends the matched attribute condition data (see FIG. 25) to the matched attribute condition display control unit 151 (S124). Moreover, the application control unit 100 sends the product candidate data (see FIG. 28) to the product list display control unit 152 (S125).

Upon receiving the product recognition start message, the voice recognition unit 110 starts voice recognition. The voice recognition is executed with the product recognition word data (see FIG. 29) registered in the product recognition word DB 240 earlier as a recognition word. The voice recognition makes it possible to obtain a product name from uttered contents of the user.

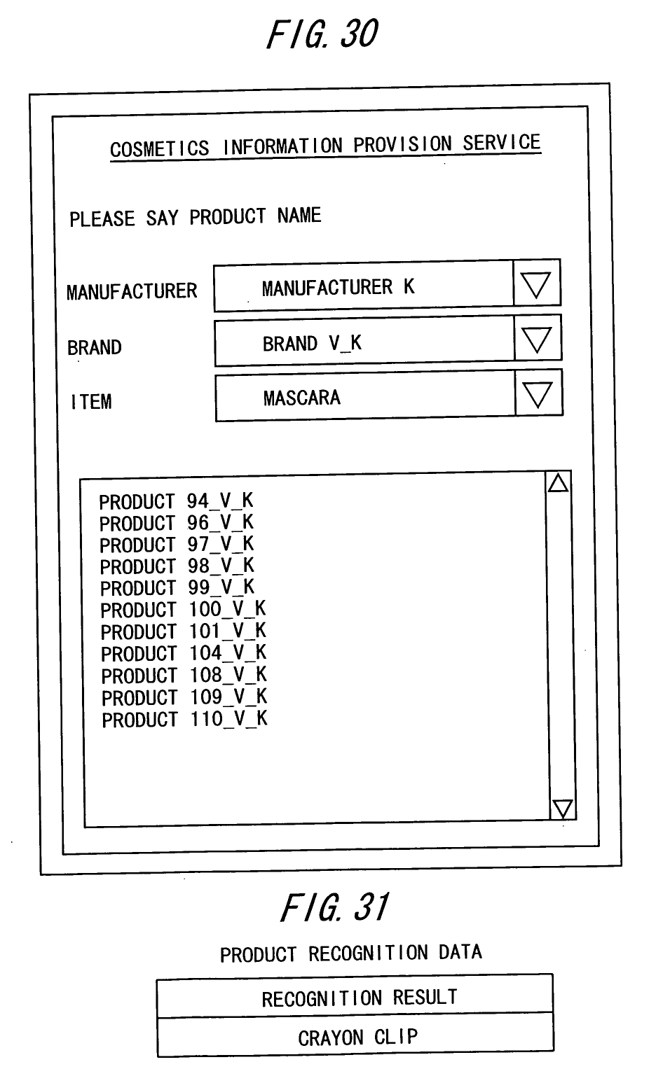

On the other hand, upon receiving the matched attribute condition data (see FIG. 25), the matched attribute condition display control unit 151 instructs the product selection screen display unit 150 to display attributes. In addition, upon receiving the product candidate data (see FIG. 28), the product list display control unit 152 instructs the product selection screen display unit 150 to display products. As a result, a product selection screen image (see FIG. 30) is displayed on the display 20. The product selection screen image includes an indication facilitating the user to utter words (voice input) concerning a product name such as “shouhinmei wo osshattekudasai (please say a product name).”

(User, Utterance of a Product)

The user, who has inspected the product selection screen image, utters a desired product name at the microphone 10. Here, it is assumed that the user has uttered “shouhinhyakubuikei (product 100_V_K)” out of a product list included in the product selection screen image (see FIG. 30).

(Voice Recognition for a Product)

Uttered contents (inputted voice data) of the user inputted via the microphone 10 are sent to the voice recognition unit 110 (S126). Upon receiving the inputted voice data, the voice recognition unit 110 applies publicly-known voice recognition (processing) to the inputted voice data. More specifically, the voice recognition unit 110 executes voice recognition with the product recognition word data (see FIG. 29) registered in the product recognition word DB 240 earlier as a recognition word.

Consequently, the voice recognition unit 110 recognizes a product name (here, a product 100_V_K) from uttered contents of the user (here, “shouhinhyakubuikei (product 100_V_K)”). FIG. 31 shows an example of a result of the recognition. The voice recognition unit 110 sends the recognition result (the product 100_V_K) to the application control unit 100 as product recognition data (S127).

(Provision of Information on a Product)

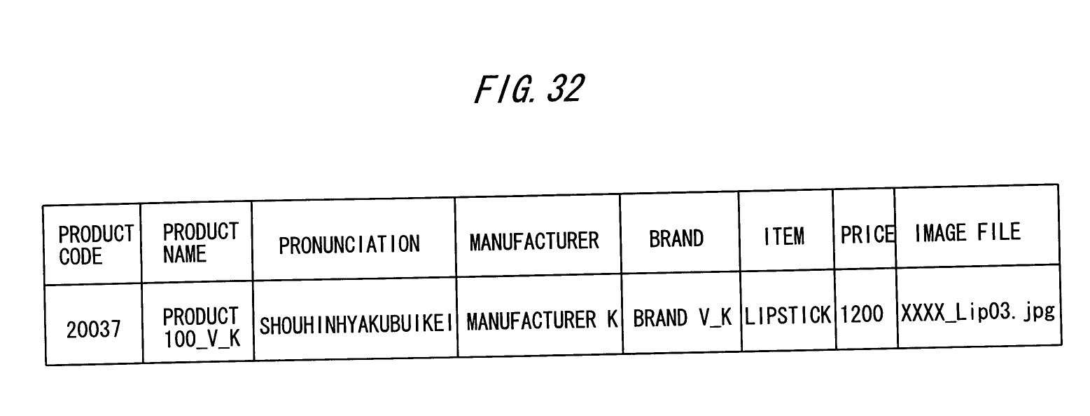

Upon receiving the product recognition data (product 100_V_K), the application control unit 100 creates product candidate data corresponding to the received product recognition data. FIG. 32 shows an example of the product candidate data. The product candidate data is created by extracting product candidates corresponding to the product recognition data received earlier from the product candidate data (e.g., the product candidate data received from the product candidate extracting unit 140). The application control unit 100 sends the created product candidate data to the product detail display unit 160 (S128).

Upon receiving the product candidate data (see FIG. 32), the product detail display unit 160 displays on the display 20 a product detail display screen image (see FIG. 33) including information (detailed information such as a product name in the product candidate data received earlier) on the product finally selected by the user (here, the product 100_V_K).

(Retrieve a Product by Changing Attribute Conditions)

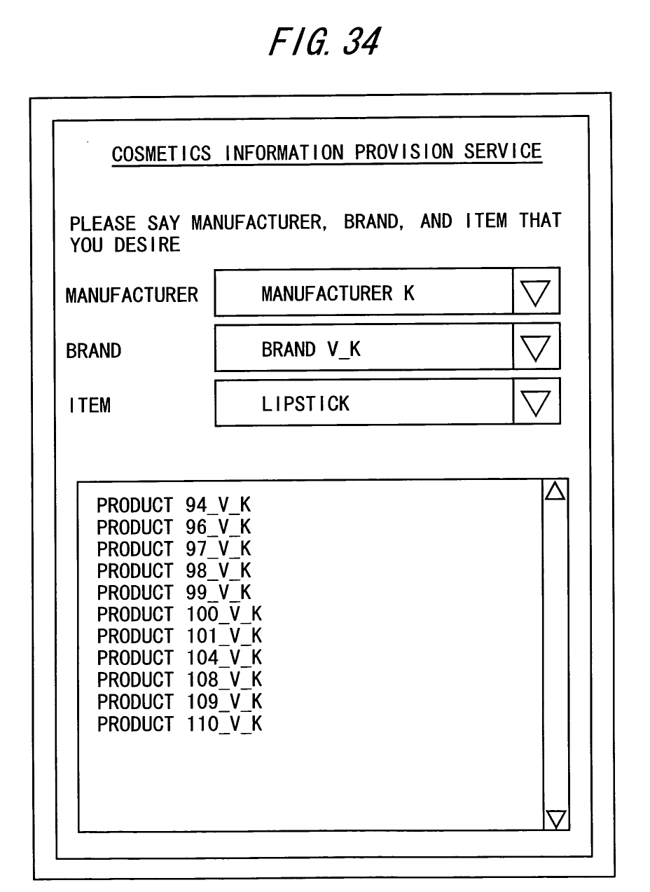

When the user presses a button “return to the previous screen” displayed on the product detail display screen image (see FIG. 33), the product detail display unit 160 sends a screen close message to the application control unit 100 (S129) and, at the same time, closes the product detail display screen. Upon receiving the screen close message, the application control unit 100 sends an attribute recognition start message to the voice recognition unit 110. A product selection screen image (see FIG. 34) is displayed on the display 20.

Next, under this situation, it is assumed that the user has further uttered an attribute value. In this case, from the viewpoint of narrowing down data efficiently or the like, matched attribute condition data is created by estimating an intention included in uttered contents of the user. The processing will be explained with reference to the drawings.

(Pattern 1: Case where the User has Uttered a Manufacturer Attribute Value Different from that in the Uttered Contents of the Last Time)

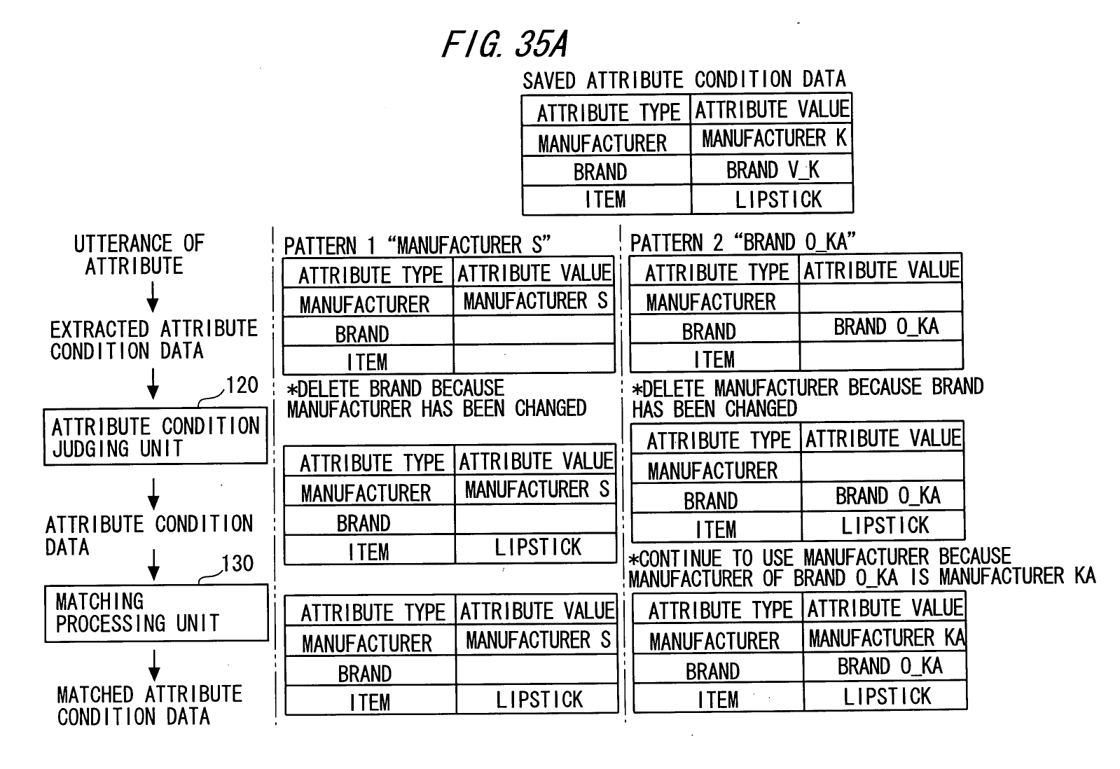

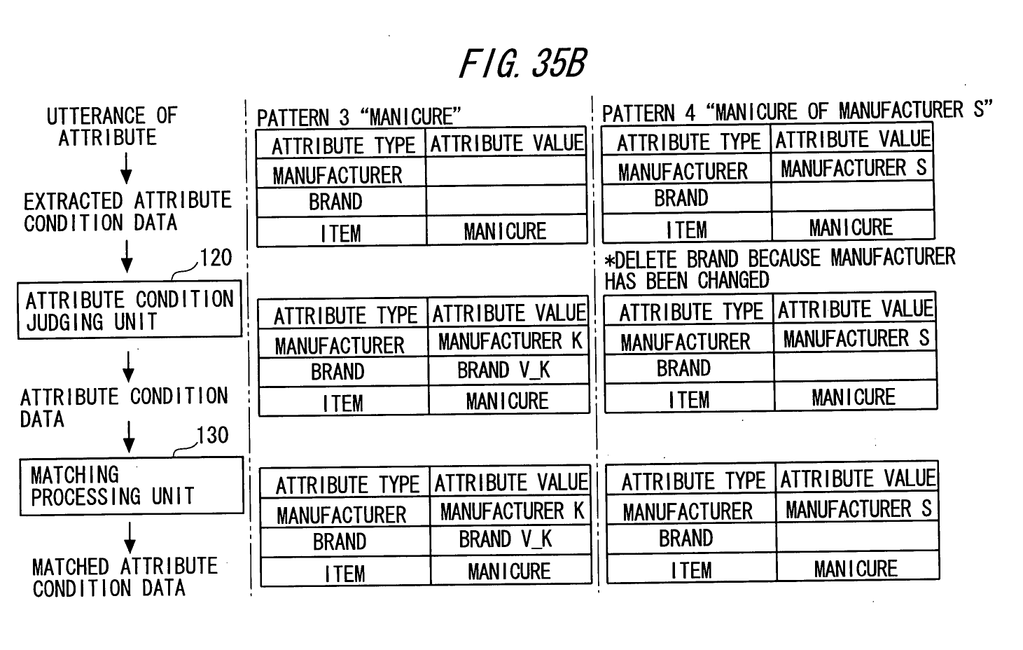

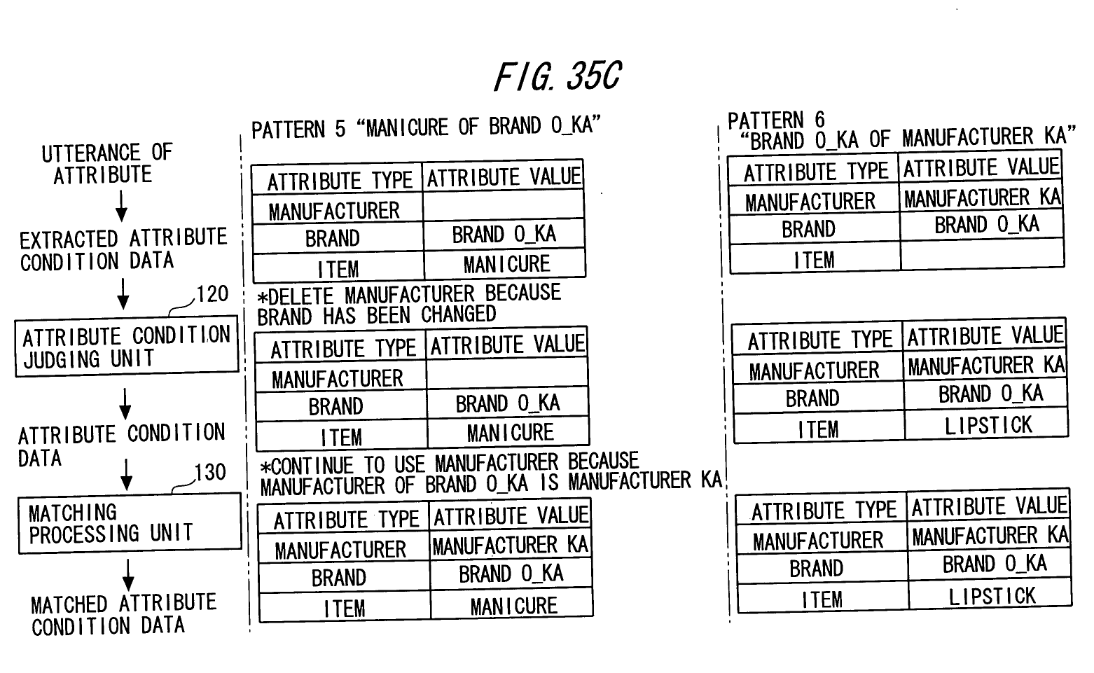

This is equivalent to a column of a pattern 1 in FIG. 35A. The column of the pattern 1 shows extracted attribute condition data, attribute condition data, and matched attribute condition data that are created in the case where the user has uttered a manufacturer attribute value (here a manufacturer S) different from that in the uttered contents of the last time under a situation in which the attribute conditions (here, the saved attribute condition data shown in FIG. 27) obtained from the uttered contents of the last time are registered in the saved attribute condition DB 230.

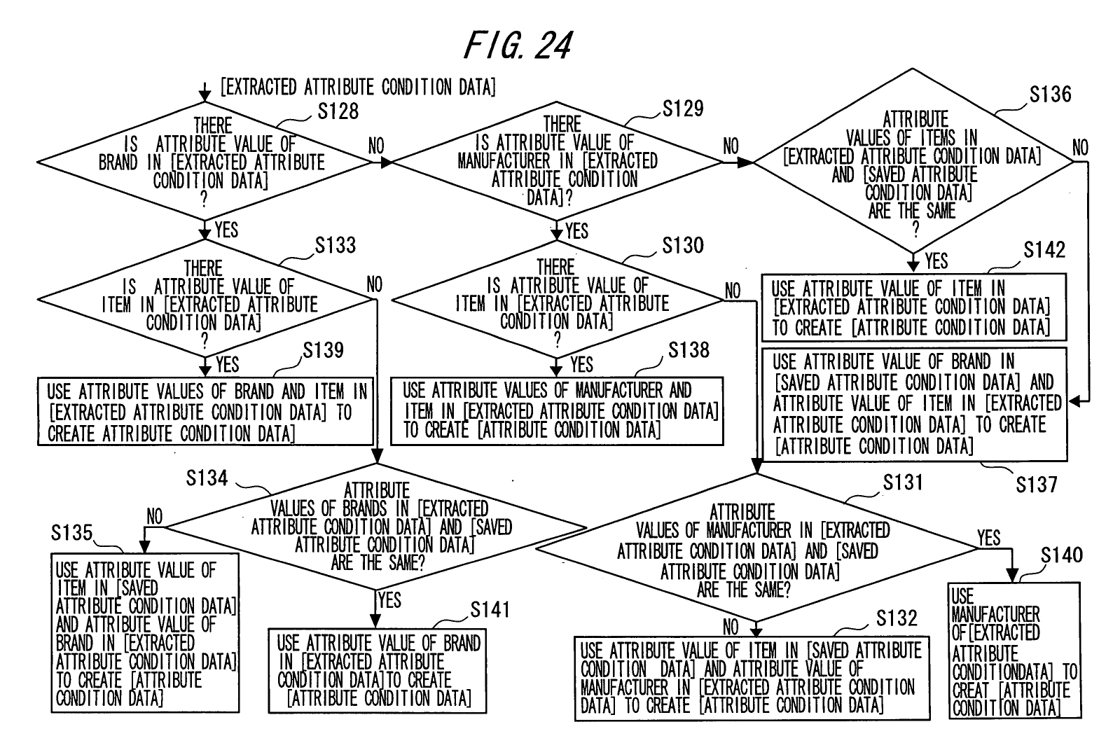

The data are created in accordance with a flowchart shown in FIG. 24 or the like. Next, it will be explained how the data are created.

(Extracted Attribute Condition Data)

This is created by the processing of S107 to S109 described above.

(Attribute Condition Data)

This is created by the processing of S110 to S114 described above.

Here, saved attribute condition data is saved in the saved attribute condition DB 230. Therefore, as shown in FIG. 23, it is judged that the saved attribute condition data is registered (Yes in S110), the registered saved attribute condition data is acquired from the saved attribute condition DB 230 (S111), attribute setting processing for estimating an intention of an uttering person is performed (S112), and attribute condition data is created (S113).

(Attribute Setting Processing)

Next, the attribute setting processing in S112 will be explained in detail with reference to FIG. 24.

First, it is judged whether there is a brand attribute value in the extracted attribute condition data (S128). Since there is no brand attribute value in the extracted attribute condition data shown in the column of the pattern 1, it is judged that there is no brand attribute (No in S128), and it is further judged whether there is a manufacturer attribute value in the extracted attribute condition data (S129). Since there is a manufacturer attribute value (the manufacturer S) in the extracted attribute condition data shown in the column of the pattern 1, it is judged that there is a manufacturer attribute value (Yes in S129), and it is further judged whether there is an item attribute value in the extracted attribute condition data (S130). Since there is no item attribute value in the extracted attribute condition data shown in the column of the pattern 1, it is judged that there is no item attribute value (No in S130), and it is further judged whether manufacturer attribute values in the extracted attribute condition data and the saved attribute data are the same (S131). Here, since the attribute values of both the data are different, it is judged that the attribute values are not the same (No in S131). In this case, attribute condition data including the item attribute value (here, the lipstick) in the saved attribute condition data acquired in S111 earlier and the manufacturer attribute value (the manufacturer S) in the extracted attribute condition data is created (S132).

This means that it is assumed that, in the case where the uttered contents of this time include only a manufacturer attribute value different from that in the uttered contents of the last time, the user (uttering person) has an intention of (1) using the manufacturer attribute value (here, the manufacturer S) included in the uttered contents of this time for the attribute condition data of this time, (2) not using the brand attribute value (here, the brand V_K) included in the uttered contents of the last time for the attribute condition data of this time (deleting the brand attribute value), and (3) continuously using the item attribute value (here, the lipstick) included in the uttered contents of the last time for the attribute condition data of this time.

(Matched Attribute Condition Data)

Next, matching processing will be explained with reference to FIG. 26.

This is created by the processing of S116 to S119.

First, it is judged whether the attribute condition data has (includes) an attribute value of a brand attribute (S116). Here, since the attribute condition data created earlier does not have an attribute value of a brand attribute (No in S116) the attribute condition data is treated as matched attribute condition data (equivalent to new retrieval conditions of the invention, this holds true for patterns described below). In this case, the attribute condition data is not edited.

Matched attribute condition data shown in a lowermost part of the column of the pattern 1 in FIG. 35A is obtained as described above. The matched attribute condition data is sent to the application control unit 100 (S119), and subjected to the same processing as that described above.

As explained above, in the pattern 1, the user only inputted the manufacturer attribute value (here, the manufacturer S) by voice. However, when the matched attribute condition data is referred to, an item attribute is also set. Moreover, a brand attribute is deleted. In this way, since the intention included in the uttered contents of the user is estimated to create the matched attribute condition data, a burden of voice input on the user can be eased (voice input efficiency is improved), and it becomes possible to narrow down data efficiently.

(Pattern 2: Case where a User has Uttered a Brand Attribute Value Different from that in the Uttered Contents of the Last Time)

This is equivalent to a column of a pattern 2 in FIG. 35A. The column of the pattern 2 shows extracted attribute condition data, attribute condition data, and matched attribute condition data that are created in the case where the user has uttered a brand attribute value (here a brand O_KA) different from that in the uttered contents of last time under a situation in which the attribute conditions (here, the saved attribute condition data shown in FIG. 27) obtained from the uttered contents of the last time are registered in the saved attribute condition DB 230.

The data are created in accordance with the flowchart shown in FIG. 24 or the like. Next, it will be explained how the data are created.

(Extracted Attribute Condition Data)

This is created by the processing of S107 to S109 described above.

(Attribute Condition Data)

This is created by the processing of S110 to S114 described above.

Here, saved attribute condition data is saved in the saved attribute condition DB 230. Therefore, as shown in FIG. 23, it is judged that the saved attribute condition data is registered (Yes in S110), the registered saved attribute condition data is acquired from the saved attribute condition DB 230 (S111), attribute setting processing for estimating an intention of an uttering person is performed (S112), and attribute condition data is created (S113).

(Attribute Setting Processing)

Next, the attribute setting processing in S112 will be explained in detail with reference to FIG. 24.

First, it is judged whether there is a brand attribute value in the extracted attribute condition data (S128). Since there is a brand attribute value in the extracted attribute condition data shown in the column of the pattern 2, it is judged that there is a brand attribute value (Yes in S128), and it is further judged whether there is an item attribute value in the extracted attribute condition data (S133). Since there is no item attribute value in the extracted attribute condition data shown in the column of the pattern 2, it is judged that there is no item attribute value (No in S133), and it is judged whether brand attribute values in the extracted condition data and the saved attribute data are the same (S134). Here, since the attribute values in both the data are different, it is judged that the attribute values are not the same (No in S134). In this case, attribute condition data including an item attribute value (here, a lipstick) in the saved attribute condition data acquired in S111 earlier and a brand attribute value (here, the brand O_KA) in the extracted attribute condition data is created (S135).

This means that it is assumed that, in the case where the uttered contents of this time include only a brand attribute value different from that in the uttered contents of the last time, the user (uttering person) has an intention of (1) not using the manufacturer attribute value (here, the manufacturer KA) included in the uttered contents of this time for the attribute condition data of this time (deleting the manufacturer attribute value), (2) using the brand attribute value (here, the brand O_KA) included in the uttered contents of this time for the attribute condition data of this time, and (3) continuously using the item attribute value (here, the lipstick) included in the uttered contents of the last time for the attribute condition data of this time.

(Matched Attribute Condition Data)

Next, matching processing will be explained with reference to FIG. 26.

This is created by the processing of S116 to S119.

First, it is judged whether the attribute condition data has (includes) an attribute value of a brand attribute (S116). Here, since the attribute condition data created earlier has an attribute value (the brand O_KA) of a brand attribute (Yes in S116), the attribute value data of the brand attribute in the attribute value DB 210 (see FIG. 17) is referred to, and an attribute value (here, a manufacturer KA) of a manufacturer sub-attribute corresponding to the attribute value (the brand O_KA) of the brand attribute is acquired (S117). Then, the acquired attribute value (here, the manufacturer KA) of the manufacturer sub-attribute (manufacturer to which the attribute value belongs) and an attribute value (here, blank) of a manufacturer attribute in the attribute condition data are compared. In this case, both the attribute values do not coincide with each other. In other words, the combination of the attribute values is not correct. Thus, attribute condition data (matched attribute condition data), in which the attribute value part (here, blank) of the manufacturer attribute in the attribute condition data is corrected (edited) by the attribute value (here, the manufacturer KA) acquired in S117, is created.

Extracted attribute condition data shown in a lowermost part of the column of the pattern 2 in FIG. 35A is obtained as described above. The extracted attribute condition data is sent to the application control unit 100 (S119), and subjected to the same processing as that described above.

As explained above, in the pattern 2, the user only inputted the brand attribute value (here, the brand O_KA) by voice. However, when the matched attribute condition data is referred to, a manufacturer attribute and an item attribute are also set. In this way, since the intention included in the uttered contents of the user is estimated to create the matched attribute condition data, a burden of voice input on the user can be eased (voice input efficiency is improved), and it becomes possible to narrow down data efficiently.

(Pattern 3: Case where a User has Uttered an Item Attribute Value Different from that in the Uttered Contents of the Last Time)

This is equivalent to a column of a pattern 3 in FIG. 35B. The column of the pattern 3 shows extracted attribute condition data, attribute condition data, and matched attribute condition data that are created in the case where the user has uttered an item attribute value (here a manicure) different from that in the uttered contents of last time under a situation in which the attribute conditions (here, the saved attribute condition data shown in FIG. 27) obtained from the uttered contents of the last time are registered in the saved attribute condition DB 230.

The data are created in accordance with the flowchart shown in FIG. 24 or the like. Next, it will be explained how the data are created.

(Extracted Attribute Condition Data)

This is created by the processing of S107 to S109 described above.

(Attribute Condition Data)

This is created by the processing of S110 to S114 described above.

Here, saved attribute condition data is saved in the saved attribute condition DB 230. Therefore, it is judged that the saved attribute condition data is registered (Yes in S110), the registered saved attribute condition data is acquired from the saved attribute condition DB 230 (S111), attribute setting processing for estimating an intention of an uttering person is performed (S112), and attribute condition data is created (S113).

(Attribute Setting Processing)

Next, the attribute setting processing in S112 will be explained in detail with reference to FIG. 24.

First, it is judged whether there is a brand attribute value in the extracted attribute condition data (S128). Since there is no brand attribute value in the extracted attribute condition data shown in the column of the pattern 3, it is judged that there is no brand attribute value (no in S128), and it is further judged whether there is a manufacturer attribute value in the extracted attribute condition data (S129). Since there is no manufacturer attribute value in the extracted attribute condition data shown in the column of the pattern 3, it is judged that there is no manufacturer attribute value (No in S129), and it is further judged whether item attribute values in the extracted attribute condition data and the saved attribute data are the same (S136). Here, since the attribute values in both the data are different, it is judged that the attribute values are not the same (No in S136). In this case, attribute condition data including a brand attribute value (here, a brand V_K) in the saved attribute condition data acquired in S111 earlier, an a item attribute value (here, the manicure) of the extracted attribute condition data, and a manufacturer attribute value (here, the manufacturer KA) is created (S137).

This means that it is assumed that, in the case where the uttered contents of this time include only an item attribute value different from that in the uttered contents of the last time, the user (uttering person) has an intention of (1) continuously using the manufacturer attribute value (here, the manufacturer KA) and the brand attribute value (here, the brand V_K) included in the uttered contents of this time for the attribute condition data of this time, and (2) using the item attribute value (here, the manicure) included in the uttered contents of this time for the attribute condition data of this time.

(Matched Attribute Condition Data)

Next, matching processing will be explained with reference to FIG. 26.

This is created by the processing of S116 to S119.

First, it is judged whether the attribute condition data has (includes) an attribute value of a brand attribute (S116). Here, since the attribute condition data created earlier has an attribute value (the brand V_K) of a brand attribute (Yes in S116), the brand value data of the brand attribute in the attribute value DB 210 (see FIG. 17) is referred to, and an attribute value (here, a manufacturer KA) of a manufacturer sub-attribute corresponding to the attribute value (the brand V_K) of the brand attribute is acquired (S117). Then, the acquired attribute value (here, the manufacturer KA) of the manufacturer sub-attribute (manufacturer to which the attribute value belongs) and an attribute value (the manufacturer KA) of a manufacturer attribute in the attribute condition data are compared. In this case, both the attribute values coincide with each other. In this case, the attribute condition data received earlier is treated as matched attribute condition data. In this case, the attribute condition data is not edited.

Matched attribute condition data shown in a lowermost part of the column of the pattern 3 in FIG. 35B is obtained as described above. The extracted attribute condition data is sent to the application control unit 100 (S119), and subjected to the same processing as that described above.

As explained above, in the pattern 3, the user only inputted the item attribute value (here, the manicure) by voice. However, when the matched attribute condition data is referred to, a manufacturer attribute and a brand attribute are also set. In this way, since the intention included in the uttered contents of the user is estimated to create the matched attribute condition data, a burden of voice input on the user can be eased (voice input efficiency is improved), and it becomes possible to narrow down data efficiently.

(Pattern 4: Case where a User has Uttered a Manufacturer Attribute Value and an Item Attribute Value Different from those in the Uttered Contents of the Last Time)

This is equivalent to a column of a pattern 4 in FIG. 35B. The column of the pattern 4 shows extracted attribute condition data, attribute condition data, and matched attribute condition data that are created in the case where the user has uttered a manufacturer attribute value and an item attribute value (here a manicure of a manufacturer S) different from those in the uttered contents of last time under a situation in which the attribute conditions (here, the saved attribute condition data shown in FIG. 27) obtained from the uttered contents of the last time are registered in the saved attribute condition DB 230.

The data are created in accordance with the flowchart shown in FIG. 24 or the like. Next, it will be explained how the data are created.

(Extracted Attribute Condition Data)

This is created by the processing of S107 to S109 described above.

(Attribute Condition Data)

This is created by the processing of S110 to S114 described above.

Here, saved attribute condition data is saved in the saved attribute condition DB 230. Therefore, it is judged that the saved attribute condition data is registered (Yes in S110), the registered saved attribute condition data is acquired from the saved attribute condition DB 230 (S111), attribute setting processing for estimating an intention of an uttering person is performed (S112), and attribute condition data is created (S113).

(Attribute Setting Processing)

Next, the attribute setting processing in S112 will be explained in detail with reference to FIG. 24.

First, it is judged whether there is a brand attribute value in the extracted attribute condition data (S128). Since there is no brand attribute value in the extracted attribute condition data shown in the column of the pattern 4, it is judged that there is no brand attribute value (No in S128), and it is further judged whether there is a manufacturer attribute value in the extracted attribute condition data (S129). Since there is a manufacturer attribute value in the extracted attribute condition data shown in the column of the pattern 4, it is judged that there is a manufacturer attribute value (Yes in S129), and it is further judged whether there is an item attribute value in the extracted attribute condition data (S130). Since there is an item attribute value in the extracted attribute condition data shown in the column of the pattern 4, it is judged that there is an item attribute value (Yes in S130). In this case, attribute condition data including a manufacture attribute value and an item attribute value (here, the manufacturer S and a manicure) of the extracted attribute condition data is created (S138).

This means that it is assumed that, in the case where the uttered contents of this time include only a manufacturer attribute value and an item attribute value different from those in the uttered contents of the last time, the user (uttering person) has an intention of (1) using the manufacturer attribute value and the item attribute value (here, the manufacturer S and a manicure) included in the uttered contents of this time for the attribute condition data of this time, and (2) not using the brand attribute value (here, the brand V_K) included in the uttered contents of last time for the attribute condition data of this time (deleting the brand attribute value).

(Matched Attribute Condition Data)

Next, matching processing will be explained with reference to FIG. 26.

First, it is judged whether the attribute condition data has (includes) an attribute value of a brand attribute (S116). Here, since the attribute condition data created earlier has no attribute value of a brand attribute (No in S116), the attribute condition data is treated as matched attribute condition data. In this case, the attribute condition data is not edited.

Matched attribute condition data shown in a lowermost part of the column of the pattern 4 in FIG. 35B is obtained as described above. The extracted attribute condition data is sent to the application control unit 100 (S119), and subjected to the same processing as that described above.

As explained above, in the pattern 4, the user only inputted the manufacturer attribute value and the item attribute value (here, the manufacturer S and manicure) by voice. However, when the matched attribute condition data is referred to, a manufacturer attribute value and an item attribute value are also set and, at the same time, a brand attribute value is deleted. In this way, since the intention included in the uttered contents of the user is estimated to create the matched attribute condition data, a burden of voice input on the user can be eased (voice input efficiency is improved), and it becomes possible to narrow down data efficiently.

(Pattern 5: Case where a User has Uttered a Brand Attribute Value and an Item Attribute Value Different from those in the Uttered Contents of the Last Time)

This is equivalent to a column of a pattern 5 in FIG. 35C. The column of the pattern 5 shows extracted attribute condition data, attribute condition data, and matched attribute condition data that are created in the case where the user has uttered a brand attribute value and an item attribute value (here a manicure of brand O_KA) different from those in the uttered contents of last time under a situation in which the attribute conditions (here, the saved attribute condition data shown in FIG. 27) obtained from the uttered contents of the last time are registered in the saved attribute condition DB 230.

The data are created in accordance with the flowchart shown in FIG. 24 or the like. Next, it will be explained how the data are created.

(Extracted Attribute Condition Data)

This is created by the processing of S107 to S109 described above.

(Attribute Condition Data)

This is created by the processing of S110 to S114 described above.

Here, saved attribute condition data is saved in the saved attribute condition DB 230. Therefore, as shown in FIG. 23, it is judged that the saved attribute condition data is registered (Yes in S110), the registered saved attribute condition data is acquired from the saved attribute condition DB 230 (S111), attribute setting processing for estimating an intention of an uttering person is performed (S112), and attribute condition data is created (S113).

(Attribute Setting Processing)

Next, the attribute setting processing in S112 will be explained in detail with reference to FIG. 24.

First, it is judged whether there is a brand attribute value in the extracted attribute condition data (S128). Since there is a brand attribute value in the extracted attribute condition data shown in the column of the pattern 5, it is judged that there is a brand attribute value (Yes in S128), and it is further judged whether there is an item attribute value in the extracted attribute condition data shown in the column of the pattern 5 (S133). Since there is an item attribute value in the extracted attribute condition data shown in the column of the pattern 5, it is judged that there is an item attribute value (Yes in S133). In this case, attribute condition data including a brand attribute value and an item attribute value (here, the brand O_KA S and a manicure) of the extracted attribute condition data is created (S139).

This means that it is assumed that, in the case where the uttered contents of this time include only a brand attribute value and an item attribute value different from those in the uttered contents of the last time, the user (uttering person) has an intention of (1) continuously using the brand attribute value and the item attribute value (here, the brand O_KA and the manicure) included in the uttered contents of this time for the attribute condition data of this time, and (2) not using the manufacturer attribute value (here, the manufacturer KA) included in the uttered contents of this time for the attribute condition data of this time (deleting the manufacturer attribute value).

(Matched Attribute Condition Data)

This is created by the processing of S116 to S119.

First, it is judged whether the attribute condition data has (includes) an attribute value of a brand attribute (S116). Here, since the attribute condition data created earlier has an attribute value (the brand O_KA) of a brand attribute (Yes in S116), the brand value data of the brand attribute in the attribute value DB 210 (see FIG. 17) is referred to, and an attribute value (here, a manufacturer KA) of a manufacturer sub-attribute corresponding to the attribute value (the brand O_KA) of the brand attribute is acquired (S117). Then, the acquired attribute value (here, the manufacturer KA) of the manufacturer sub-attribute (manufacturer to which the attribute value belongs) and an attribute value (here, blank) of a manufacturer attribute in the attribute condition data are compared. In this case, both the attribute values do not coincide with each other. In other words, the combination of the attribute values is not correct. Thus, attribute condition data (matched attribute condition data), in which the attribute value part (here, blank) of the manufacturer attribute in the attribute condition data is corrected (edited) by the attribute value (here, the manufacturer KA) acquired earlier, is created.

Extracted attribute condition data shown in a lowermost part of the column of the pattern 2 in FIG. 35A is obtained as described above. The extracted condition data is sent to the application control unit 100 (S119), and subjected to the same processing as that described above.

As explained above, in the pattern 5, the user only inputted the brand attribute value and the item attribute value (here, the brand O_KA and the manicure) by voice. However, when the matched attribute condition data is referred to, a manufacturer attribute value is also set. In this way, since the intention included in the uttered contents of the user is estimated to create the matched attribute condition data, a burden of voice input on the user can be eased (voice input efficiency is improved), and it becomes possible to narrow down data efficiently.

(Pattern 6: Case where a User has Uttered a Manufacturer Attribute Value and a Brand Attribute Value Different from those in the Uttered Contents of the Last Time)

This is equivalent to a column of a pattern 6 in FIG. 35C. The column of the pattern 6 shows extracted attribute condition data, attribute condition data, and matched attribute condition data that are created in the case where the user has uttered a manufacturer attribute value and a brand attribute value “brand O_KA of manufacture KA” under a situation in which the attribute conditions (here, the saved attribute condition data shown in FIG. 27) obtained from the uttered contents of the last time are registered in the saved attribute condition DB 230.

The data are created in accordance with the flowchart shown in FIG. 24 or the like. Next, it will be explained how the data are created.

(Extracted Attribute Condition Data)

This is created by the processing of S107 to S109 described above.

(Attribute Condition Data)

This is created by the processing of S110 to S114 described above.

Here, saved attribute condition data is saved in the saved attribute condition DB 230. Therefore, as shown in FIG. 23, it is judged that the saved attribute condition data is registered (Yes in S110), the registered saved attribute condition data is acquired from the saved attribute condition DB 230 (S111), attribute setting processing for estimating an intention of an uttering person is performed (S112), and attribute condition data is created (S113).

(Attribute Setting Processing)

Next, the attribute setting processing in S112 will be explained in detail with reference to FIG. 24.

First, it is judged whether there is a brand attribute value in the extracted attribute condition data (S128). Since there is a brand attribute value in the extracted attribute condition data shown in the column of the pattern 6, it is judged that there is a brand attribute value (Yes in S128), and it is further judged whether there is an item attribute value in the extracted attribute condition data (S133). Since there is no item attribute value in the extracted attribute condition data shown in the column of the pattern 6, it is judged that there is no item attribute value (No in S133), and it is judged whether brand attribute values in the extracted condition data and the saved attribute condition data are the same (S134). Here, since the attribute values in both the data are different, it is judged that the attribute values are not the same (No in S134). In this case, attribute condition data including an item attribute value (here, a lipstick) in the saved attribute condition data acquired in S111 earlier and a manufacturer attribute value and a brand attribute value (here, the manufacture KA and the brand O_KA) of the extracted attribute condition data is created (S135).

This means that it is assumed that, in the case where the uttered contents of this time include only a manufacturer attribute value and a brand attribute value different from those in the uttered contents of the last time, the user (uttering person) has an intention of: using the manufacturer attribute value and the brand attribute value (here, the manufacturer KA and the brand O_KA) included in the uttered contents of this time for the attribute condition data of this time; and continuously using the item attribute value (here, the lipstick) included in the uttered contents of last time for the attribute condition data of this time.

(Matched Attribute Condition Data)

Next, matching processing will be explained with reference to FIG. 26.

First, it is judged whether the attribute condition data has (includes) an attribute value of a brand attribute (S116). Here, since the attribute condition data created earlier has an attribute value (the brand O_KA) of a brand attribute (Yes in S116) the brand value data of the brand attribute in the attribute value DB 210 (see FIG. 17) is referred to, and an attribute value (here, a manufacturer KA) of a manufacturer sub-attribute corresponding to the attribute value (the brand O_KA) of the brand attribute is acquired (S117). Then, the acquired attribute value (here, the manufacturer KA) of the manufacturer sub-attribute (manufacturer to which the attribute value belongs) and an attribute value (manufacturer KA) of a manufacturer attribute in the attribute condition data are compared. In this case, both the attribute values coincide with each other. In this case, the attribute condition data is treated as matched attribute condition data.

Extracted attribute condition data shown in a lowermost part of the column of the pattern 6 in FIG. 35C is obtained as described above. The extracted attribute condition data is sent to the application control unit 100 (S119), and subjected to the same processing as that described above.

As explained above, in the pattern 6, the user only inputted the manufacturer attribute value and the brand attribute value (here, the manufacturer S and the manufacturer O_KA) by voice. However, when the matched attribute condition data is referred to, an item attribute value is also set. In this way, since the intention included in the uttered contents of the user is estimated to create the matched attribute condition data, a burden of voice input on the user can be eased (voice input efficiency is improved), and it becomes possible to narrow down data efficiently.

(Pattern 7: Case Where a User has Uttered the Same Manufacturer Attribute Value as that in the Uttered Contents of the Last Time)

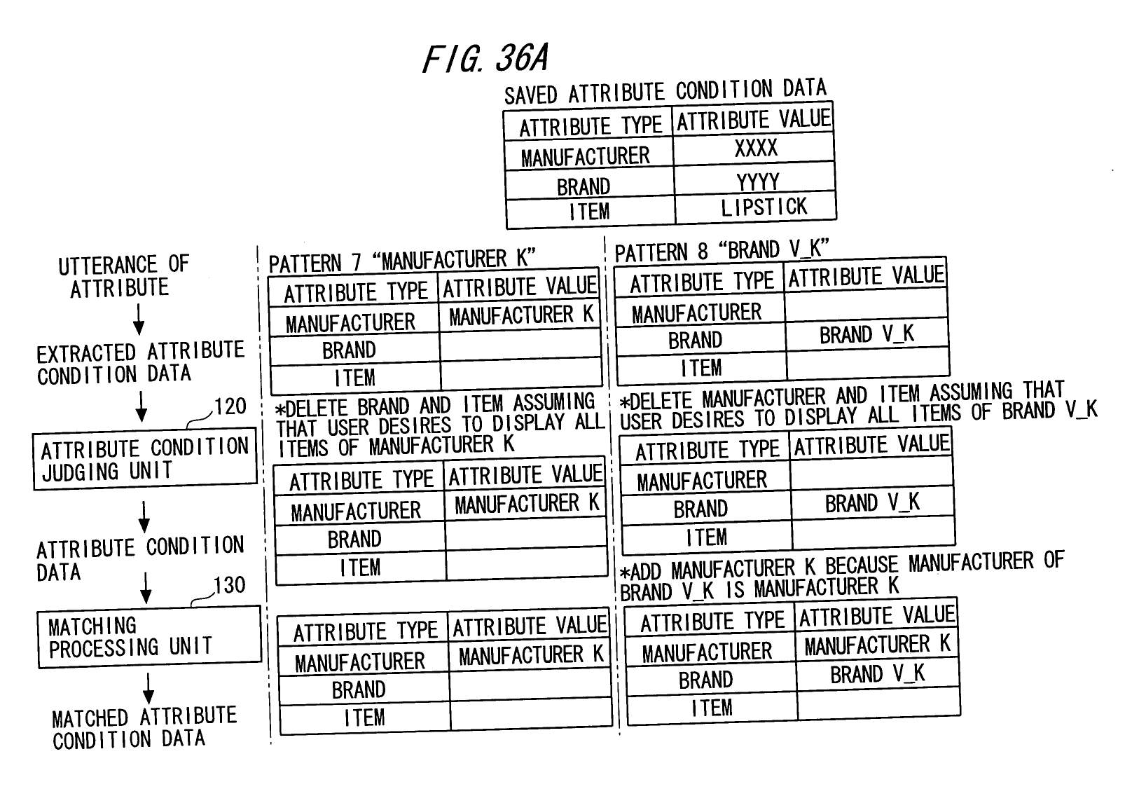

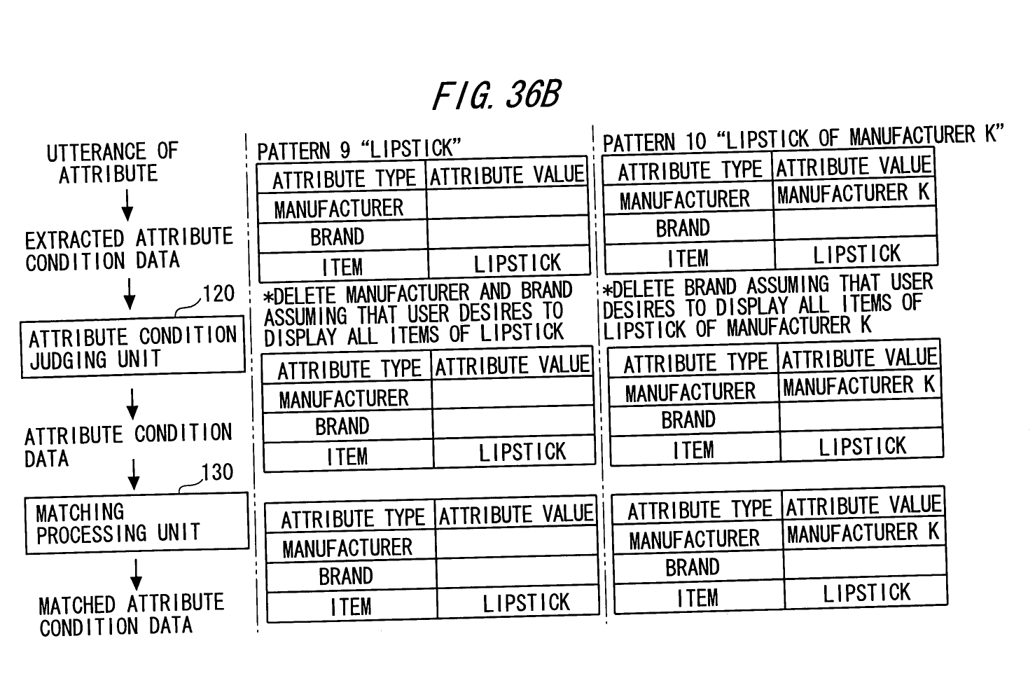

This is equivalent to a column of a pattern 7 in FIG. 36A. The column of the pattern 7 shows extracted attribute condition data, attribute condition data, and matched attribute condition data that are created in the case where the user has uttered the same manufacturer attribute value (here a manufacturer KA) as that in the uttered contents of last time under a situation in which the attribute conditions (here, the saved attribute condition data shown in FIG. 27) obtained from the uttered contents of the last time are registered in the saved attribute condition DB 230.

The data are created in accordance with the flowchart shown in FIG. 24 or the like. Next, it will be explained how the data are created.

(Extracted Attribute Condition Data)

This is created by the processing of S107 to S109 described above.

(Attribute Condition Data)

This is created by the processing of S110 to S114 described above.

Here, saved attribute condition data is saved in the saved attribute condition DB 230. Therefore, as shown in FIG. 23, it is judged that the saved attribute condition data is registered (Yes in S110), the registered saved attribute condition data is acquired from the saved attribute condition DB 230 (S111), attribute setting processing for estimating an intention of an uttering person is performed (S112), and attribute condition data is created (S113).

(Attribute Setting Processing)

Next, the attribute setting processing in S112 will be explained in detail with reference to FIG. 24.

First, it is judged whether there is a brand attribute value in the extracted attribute condition data (S128). Since there is no brand attribute value in the extracted attribute condition data shown in the column of the pattern 7, it is judged that there is no brand attribute value (no in S128), and it is further judged whether there is a manufacturer attribute value in the extracted attribute condition data (S129). Since there is a manufacturer attribute value (manufacture KA) in the extracted attribute condition data shown in the column of the pattern 7, it is judged that there is a manufacturer attribute value (Yes in S129), and it is further judged whether there is an item attribute in the extracted attribute condition data (S130). Since there is no item attribute value in the extracted attribute condition data shown in the column of the pattern 7, it is judged that there is no item attribute value (no in S130), and it is judged whether manufacturer attribute values in the extracted condition data and the saved attribute data are the same (S131). Here, since the attribute values in both the data are same, it is judged that the attribute values are the same (Yes in S131). In this case, attribute condition data including a manufacture attribute value (here, the manufacturer KA) of the extracted attribute condition data is created (S140).

This means that it is assumed that, in the case where the uttered contents of this time include only the same manufacturer attribute value as that in the uttered contents of the last time, the user (uttering person) has an intention of (1) using the manufacturer attribute value (here, the manufacturer KA) included in the uttered contents of this time and of for the attribute condition data of this time, and of not using the brand attribute value and the item attribute value (here, the brand V_K and the lipstick) included in the uttered contents of this time for the attribute condition data of this time (deleting the brand attribute value and the item attribute value).

(Matched Attribute Condition Data)

Next, matching processing will be explained with reference to FIG. 26.

This is created by the processing of S116 to S119.

First, it is judged whether the attribute condition data has (includes) an attribute value of a brand attribute (S116). Here, since the attribute condition data created earlier has no attribute value of a brand attribute (No in S116), the attribute condition data is treated as matched attribute condition data. In this case, the attribute condition data is not edited.

Extracted attribute condition data shown in a lowermost part of the column of the pattern 7 in FIG. 36A is obtained as described above. The extracted attribute condition data is sent to the application control unit 100 (S119), and subjected to the same processing as that described above.

As explained above, in the pattern 7, the user only inputted the manufacturer attribute value (here, the manufacturer KA) by voice. However, when the matched attribute condition data is referred to, a brand attribute and an item attribute are deleted. In this way, since the intention included in the uttered contents of the user is estimated to create the matched attribute condition data, a burden of voice input on the user can be eased (voice input efficiency is improved), and it becomes possible to narrow down data efficiently.

(Pattern 8: Case where a User has Uttered the Same Brand Attribute Value as that in the Uttered Contents of the Last Time)

This is equivalent to a column of a pattern 8 in FIG. 36A. The column of the pattern 8 shows extracted attribute condition data, attribute condition data, and matched attribute condition data that are created in the case where the user has uttered a brand attribute value “brand V_K” different from that in the uttered contents of last time under a situation in which the attribute conditions (here, the saved attribute condition data shown in FIG. 27) obtained from the uttered contents of the last time are registered in the saved attribute condition DB 230.

The data are created in accordance with the flowchart shown in FIG. 24 or the like. Next, it will be explained how the data are created.

(Extracted Attribute Condition Data)

This is created by the processing of S107 to S109 described above.

(Attribute Condition Data)

This is created by the processing of S110 to S114 described above.

Here, saved attribute condition data is saved in the saved attribute condition DB 230. Therefore, as shown in FIG. 23, it is judged that the saved attribute condition data is registered (Yes in S110), the registered saved attribute condition data is acquired from the saved attribute condition DB 230 (S111), attribute setting processing for estimating an intention of an uttering person is performed (S112), and attribute condition data is created (S113).

(Attribute Setting Processing)

Next, the attribute setting processing in S112 will be explained in detail with reference to FIG. 24.

First, it is judged whether there is a brand attribute value in the extracted attribute condition data (S128). Since there is a brand attribute value in the extracted attribute condition data shown in the column of the pattern 8, it is judged that there is a brand attribute value (Yes in S128), and it is further judged whether there is an item attribute value in the extracted attribute condition data (S133). Since there is no item attribute value in the extracted attribute condition data shown in the column of the pattern 8, it is judged that there is no item attribute value (No in S133), and it is judged whether brand attribute values in the extracted condition data and the saved attribute data are the same (S134). Here, since the attribute values in both the data are same, it is judged that the attribute values are the same (Yes in S134). In this case, attribute condition data including a brand attribute value (here, the brand V_K) of the extracted attribute condition data is created (S141).

This means that it is assumed that, in the case where the uttered contents of this time include only the same brand attribute value as that in the uttered contents of the last time, the user (uttering person) has an intention of (1) not using the manufacturer attribute value and the item attribute value (here, the manufacturer KA and the lipstick) included in the uttered contents of this time for the attribute condition data of this time (deleting the manufacturer attribute value and the item attribute value), and (2) using the brand attribute value (here, the brand V_K) included in the uttered contents of this time for the attribute condition data of this time.

(Matched Attribute Condition Data)

Next, matching processing will be explained with reference to FIG. 26.

This is created by the processing of S116 to S119.

First, it is judged whether the attribute condition data has (includes) an attribute value of a brand attribute (S116). Here, since the attribute condition data created earlier has an attribute value (the brand V_K) of a brand attribute (Yes in S116), the brand value data of the brand attribute in the attribute value DB 210 (see FIG. 17) is referred to, and an attribute value (here, a manufacturer KA) of a manufacturer sub-attribute corresponding to the attribute value (the brand V_K) of the brand attribute is acquired (S117). Then, the acquired attribute value (the manufacturer KA) of the manufacturer sub-attribute (manufacturer to which the attribute value belongs) and an attribute value (here, blank) of a manufacturer attribute in the attribute condition data are compared. In this case, both the attribute values do not coincide with each other. In other words, the combination of the attribute values is not correct. Thus, attribute condition data (matched attribute condition data), in which the attribute value part (blank) of the manufacturer attribute in the attribute condition data is corrected (edited) by the attribute value (here, the manufacturer KA) acquired earlier, is created.

Extracted attribute condition data shown in a lowermost part of the column of the pattern 8 in FIG. 36A is obtained as described above. The extracted attribute condition data is sent to the application control unit 100 (S119), and subjected to the same processing as that described above.

As explained above, in the pattern 8, the user only inputted the brand attribute value (here, the brand V_K) by voice. However, when the matched attribute condition data is referred to, a manufacturer attribute value is also set. Moreover, an item attribute value is deleted. In this way, since the intention included in the uttered contents of the user is estimated to create the matched attribute condition data, a burden of voice input on the user can be eased (voice input efficiency is improved), and it becomes possible to narrow down data efficiently.

(Pattern 9: Case where a User has Uttered the Same Item Attribute Value as that in the Uttered Contents of the Last Time)

This is equivalent to a column of a pattern 9 in FIG. 36B. The column of the pattern 9 shows extracted attribute condition data, attribute condition data, and matched attribute condition data that are created in the case where the user has uttered the same item attribute value (here a lipstick) as that in the uttered contents of last time under a situation in which the attribute conditions (here, the saved attribute condition data shown in FIG. 27) obtained from the uttered contents of the last time are registered in the saved attribute condition DB 230.

The data are created in accordance with the flowchart shown in FIG. 24 or the like. Next, it will be explained how the data are created.

(Extracted Attribute Condition Data)

This is created by the processing of S107 to S109 described above.
(Attribute Condition Data)

This is created by the processing of S110 to S114 described above.

More specifically, as shown in FIG. 23, first, it is judged whether saved attribute condition data (see FIG. 27) is registered in the saved attribute condition DB 230 (S110). Here, saved attribute condition data is saved in the saved attribute condition DB 230. Therefore, it is judged that the saved attribute condition data is registered (Yes in S110), the registered saved attribute condition data is acquired from the saved attribute condition DB 230 (S111), attribute setting processing for estimating an intention of an uttering person is performed (S112), and attribute condition data (see FIG. 48) is created (S113).

(Attribute Setting Processing)

Next, the attribute setting processing in S112 will be explained with reference to FIG. 24.

First, it is judged whether there is a brand attribute value in the extracted attribute condition data (S128). Since there is no brand attribute value in the extracted attribute condition data shown in the column of the pattern 9, it is judged that there is no brand attribute value (No in S128), and it is further judged whether there is a manufacturer attribute value in the extracted attribute condition data (S129). Since there is no manufacturer attribute value in the extracted attribute condition data shown in the column of the pattern 9, it is judged that there is no manufacturer attribute value (No in S129), and it is judged whether the item attribute values in the extracted condition data and the saved attribute data are the same (S136). Here, since the attribute values in both the data are same, it is judged that the attribute values are same (Yes in S136). In this case, attribute condition data including an item attribute value (here, the lipstick) of the extracted attribute condition data is created (S142).

This means that it is assumed that, in the case where the uttered contents of this time include only the same item attribute value as that in the uttered contents of the last time, the user (uttering person) has an intention of (1) not using the manufacturer attribute value and the brand attribute value (here, the manufacturer KA and the brand V_K) included in the uttered contents of this time for the attribute condition data of this time (deleting the manufacturer attribute value and the brand attribute value), and (2) using the item attribute value (here, the lipstick) included in the uttered contents of this time for the attribute condition data of this time.

(Matched Attribute Condition Data)

Next, matching processing will be explained with reference to FIG. 26.

This is created by the processing of S116 to S119.

First, it is judged whether the attribute condition data has (includes) an attribute value of a brand attribute (S116). Here, since the attribute condition data created earlier has no attribute value of a brand attribute (No in S116), the attribute condition data is treated as matched attribute condition data. In this case, the attribute condition data is not edited.

Matched attribute condition data shown in a lowermost part of the column of the pattern 9 in FIG. 36B is obtained as described above. The matched attribute condition data is sent to the application control unit 100 (S119), and subjected to the same processing as that described above.

As explained above, in the pattern 9, the user only inputted the item attribute value (here, the lipstick) by voice. However, when the matched attribute condition data is referred to, a manufacture attribute value and a brand attribute value are deleted. In this way, since the intention included in the uttered contents of the user is estimated to create the matched attribute condition data, a burden of voice input on the user can be eased (voice input efficiency is improved), and it becomes possible to narrow down data efficiently.

(Pattern 10: Case where a User has Uttered the Same Manufacture Attribute Value and Item Attribute Value as those in the Uttered Contents of the Last Time)

This is equivalent to a column of a pattern 10 in FIG. 36B. The column of the pattern 10 shows extracted attribute condition data, attribute condition data, and matched attribute condition data that are created in the case where the user has uttered the same manufacturer attribute value and item attribute value (here a lipstick of manufacturer KA) as those in the uttered contents of last time under a situation in which the attribute conditions (here, the saved attribute condition data shown in FIG. 27) obtained from the uttered contents of the last time are registered in the saved attribute condition DB 230.

The data are created in accordance with the flowchart shown in FIG. 24 or the like. Next, it will be explained how the data are created.

(Extracted Attribute Condition Data)

This is created by the processing of S107 to S109 described above.

(Attribute Condition Data)

This is created by the processing of S110 to S114 described above.

Here, saved attribute condition data is saved in the saved attribute condition DB 230. Therefore, as shown in FIG. 23, it is judged that the saved attribute condition data is registered (Yes in S110), the registered saved attribute condition data is acquired from the saved attribute condition DB 230 (S111), attribute setting processing for estimating an intention of an uttering person is performed (S112), and attribute condition data is created (S113).

(Attribute Setting Processing)

Next, the attribute setting processing in S112 will be explained with reference to FIG. 24.

First, it is judged whether there is a brand attribute value in the extracted attribute condition data (S128). Since there is no brand attribute value in the extracted attribute condition data shown in the column of the pattern 10, it is judged that there is no brand attribute value (No in S128), and it is further judged whether there is a manufacturer attribute value in the extracted attribute condition data (S129). Since there is a manufacture attribute value in the extracted attribute condition data shown in the column of the pattern 10, it is judged that there is a manufacturer attribute value (Yes in S129), and it is judged whether there is an item attribute value in the extracted attribute condition data (S130). Since there is an item attribute value in the extracted attribute condition data shown in the column of the pattern 10, it is judged that there is an item attribute value (Yes in S130). In this case, attribute condition data including a manufacturer attribute value and an item attribute value (here, the manufacturer KA and the lipstick) of the extracted attribute condition data is created (S138).

This means that it is assumed that, in the case where the uttered contents of this time include only the same manufacturer attribute value and item attribute value as those in the uttered contents of the last time, the user (uttering person) has an intention of (1) using the manufacturer attribute value and the item attribute value (here, the manufacturer KA and the lipstick) included in the uttered contents of this time for the attribute condition data of this time, and of not using the brand attribute value (here, the brand V_K) included in the uttered contents of the last time for the attribute condition data of this time (deleting the brand attribute value).

(Matched Attribute Condition Data)

Next, matching processing will be explained with reference to FIG. 26.

This is created by the processing of S116 to S119.

First, it is judged whether the attribute condition data has (includes) an attribute value of a brand attribute (S116). Here, since the attribute condition data created earlier has no attribute value of a brand attribute (No in S116), the attribute condition data is treated as matched attribute condition data. In this case, the attribute condition data is not edited.

Matched attribute condition data shown in a lowermost part of the column of the pattern 10 in FIG. 36B is obtained as described above. The extracted attribute condition data is sent to the application control unit 100 (S119), and subjected to the same processing as that described above.

As explained above, in the pattern 10, the user only inputted the manufacturer attribute value and the item attribute value (here, the manufacturer KA and the lipstick) by voice. However, when the matched attribute condition data is referred to, a manufacture attribute is deleted. In this way, since the intention included in the uttered contents of the user is estimated to create the matched attribute condition data, a burden of voice input on the user can be eased (voice input efficiency is improved), and it becomes possible to narrow down data efficiently.

(Pattern 11: Case where a User has Uttered the Same Brand Attribute Value and Item Attribute Value as those in the Uttered Contents of the Last Time)

This is equivalent to a column of a pattern 11 in FIG. 36C. The column of the pattern 11 shows extracted attribute condition data, attribute condition data, and matched attribute condition data that are created in the case where the user has uttered the same brand attribute value and item attribute value (here a lipstick of brand V_A) as those in the uttered contents of last time under a situation in which the attribute conditions (here, the saved attribute condition data shown in FIG. 27) obtained from the uttered contents of the last time are registered in the saved attribute condition DB 230.

The data are created in accordance with the flowchart shown in FIG. 24 or the like. Next, it will be explained how the data are created.

(Extracted Attribute Condition Data)

This is created by the processing of S107 to S109 described above.

(Attribute Condition Data)

This is created by the processing of S110 to S114 described above.

Here, saved attribute condition data is saved in the saved attribute condition DB 230. Therefore, as shown in FIG. 23, it is judged that the saved attribute condition data is registered (Yes in S110), the registered saved attribute condition data is acquired from the saved attribute condition DB 230 (S111), attribute setting processing for estimating an intention of an uttering person is performed (S112), and attribute condition data is created (S113).

(Attribute Setting Processing)

Next, the attribute setting processing in S112 will be explained in detail with reference to FIG. 24.

First, it is judged whether there is a brand attribute value in the extracted attribute condition data (S128). Since there is a brand attribute value in the extracted attribute condition data shown in the column of the pattern 11, it is judged that there is a brand attribute value (Yes in S128), and it is further judged whether there is an item attribute value in the extracted attribute condition data (S133) shown in the column of the pattern 11. Since there is an item attribute value in the extracted attribute condition data shown in the column of the pattern 11, it is judged that there is an item attribute value (Yes in S133). In this case, attribute condition data including a brand attribute value and an item attribute value (here, the brand V_K and the lipstick) of the extracted attribute condition data is created (S139).

This means that it is assumed that, in the case where the uttered contents of this time include only the same brand attribute value and item attribute value as those in the uttered contents of the last time, the user (uttering person) has an intention of (1) using the brand attribute value and the item attribute value (here, the brand V_K and the lipstick) included in the uttered contents of this time for the attribute condition data of this time, and (2) not using the manufacturer attribute value (here, the manufacturer KA) included in the uttered contents of this time for the attribute condition data of this time (deleting the manufacturer attribute value).

(Matched Attribute Condition Data)

Next, matching processing will be explained with reference to FIG. 26.

This is created by the processing of S24 to S28.

First, it is judged whether the attribute condition data has (includes) an attribute value of a brand attribute (S116). Here, since the attribute condition data created earlier has an attribute value (the brand V_K) of a brand attribute (Yes in S116), the attribute value data of the brand attribute in the attribute value DB 210 (see FIG. 17) is referred to, and an attribute value (here, a manufacturer KA) of a manufacturer sub-attribute corresponding to the attribute value (the brand V_K) of the brand attribute is acquired (S117). Then, the acquired attribute value (here, the manufacturer KA) of the manufacturer sub-attribute (manufacturer to which the attribute value belongs) and an attribute value (here, blank) of a manufacturer attribute in the attribute condition data are compared. In this case, both the attribute values do not coincide with each other. In other words, the combination of the attribute values is not correct. Thus, attribute condition data (matched attribute condition data), in which the attribute value part (blank) of the manufacturer attribute in the attribute condition data is corrected (edited) by the attribute value (manufacturer KA) acquired earlier, is created.

Extracted attribute condition data shown in a lowermost part of the column of the pattern 11 in FIG. 36C is obtained as described above. The extracted attribute condition data is sent to the application control unit 100 (S119), and the same processing as described above is performed.

As explained above, in the pattern 11, the user only inputted the manufacturer attribute value (here, the brand V_K and the lipstick) by voice. However, when the matched attribute condition data is referred to, a manufacturer attribute value is also set. In this way, since the intention included in the uttered contents of the user is estimated to create the matched attribute condition data, a burden of voice input on the user can be eased (voice input efficiency is improved), and it becomes possible to narrow down data efficiently.

(Pattern 12: Case where a User has Uttered the Same Manufacturer Attribute Value and Brand Attribute Value as those in the Uttered Contents of the Last Time)

This is equivalent to a column of a pattern 12 in FIG. 36C. The column of the pattern 12 shows extracted attribute condition data, attribute condition data, and matched attribute condition data that are created in the case where the user has uttered the same manufacturer attribute value and brand attribute value (here a brand V_K of manufacturer KA) as those in the uttered contents of last time under a situation in which the attribute conditions (here, the saved attribute condition data shown in FIG. 27) obtained from the uttered contents of the last time are registered in the saved attribute condition DB 230.

The data are created in accordance with the flowchart shown in FIG. 24 or the like. Next, it will be explained how the data are created.

(Extracted Attribute Condition Data)

This is created by the processing of S107 to S109 described above.

(Attribute Condition Data)

This is created by the processing of S110 to S114 described above.

Here, saved attribute condition data is saved in the saved attribute condition DB 230. Therefore, as shown in FIG. 23, it is judged that the saved attribute condition data is registered (Yes in S110), the registered saved attribute condition data is acquired from the saved attribute condition DB 230 (S111), attribute setting processing for estimating an intention of an uttering person is performed (S112), and attribute condition data is created (S113).

(Attribute Setting Processing)

Next, the attribute setting processing in S112 will be explained in detail with reference to FIG. 24.

First, it is judged whether there is a brand attribute value in the extracted attribute condition data (S128). Since there is a brand attribute value in the extracted attribute condition data shown in the column of the pattern 12, it is judged that there is a brand attribute value (Yes in S128), and it is further judged whether there is an item attribute value in the extracted attribute condition data (S133). Since there is no item attribute value in the extracted attribute condition data shown in the column of the pattern 6, it is judged that there is no item attribute value (No in S133), and it is judged whether brand attribute values in the extracted condition data and the saved attribute data are the same (S134). Here, since the attribute values in both the data are the same, it is judged that the attribute values are the same (Yes in S134). In this case, attribute condition data including a manufacturer attribute value and an brand attribute value (here, the manufacturer KA and the brand V_K) of the extracted attribute condition data is created (S141).

This means that it is assumed that, in the case where the uttered contents of this time include only the same manufacturer attribute value and brand attribute value as those in the uttered contents of the last time, the user (uttering person) has an intention of (1) using the manufacturer attribute value and the brand attribute value (here, the manufacturer KA and the brand V_K) included in the uttered contents of this time for the attribute condition data of this time, and (2) not using the item attribute value (here, the lipstick) included in the uttered contents of this time for the attribute condition data of this time (deleting the item attribute value).

(Matched Attribute Condition Data)

Next, matching processing will be explained with reference to FIG. 26.

This is created by the processing of S116 to S119.

First, it is judged whether the attribute condition data has (includes) an attribute value of a brand attribute (S116). Here, since the attribute condition data created earlier has an attribute value (the brand V_K) of a brand attribute (Yes in S116), the attribute value data of the brand attribute in the attribute value DB 210 (see FIG. 17) is referred to, and an attribute value (here, a manufacturer KA) of a manufacturer sub-attribute corresponding to the attribute value (the brand V_K) of the brand attribute is acquired (S117). Then, the acquired attribute value (the manufacturer KA) of the manufacturer sub-attribute (manufacturer to which the attribute value belongs) and an attribute value (the manufacturer KA) of a manufacturer attribute in the attribute condition data are compared. In this case, both the attribute values coincide with each other. In this case, the attribute condition data is treated as matched attribute condition data.

Extracted attribute condition data shown in a lowermost part of the column of the pattern 12 in FIG. 36C is obtained as described above. The extracted attribute condition data is sent to the application control unit 100 (S119), and subjected to the same processing as that described above.

As explained above, in the pattern 12, the user only inputted the manufacturer attribute and the brand attribute (here, the manufacturer KA and the brand V_K) by voice. However, an item attribute is deleted. In this way, since the intention included in the uttered contents of the user is estimated to create the matched attribute condition data, a burden of voice input on the user can be eased (voice input efficiency is improved), and it becomes possible to narrow down data efficiently.

Next, a car information provision application (car information retrieval system), which is a second embodiment of the invention, will be explained with reference to the drawings.

(Car Information Provision Application)

Since the car information provision application (car information retrieval system) is the same as the cosmetics information provision application explained in the first embodiment, differences will be mainly explained with reference to FIG. 15.

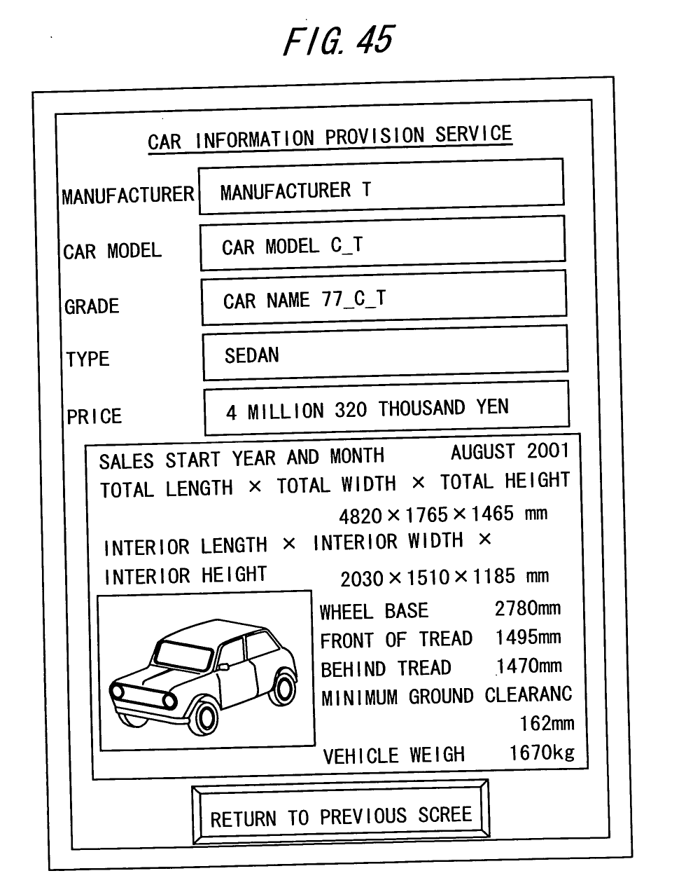

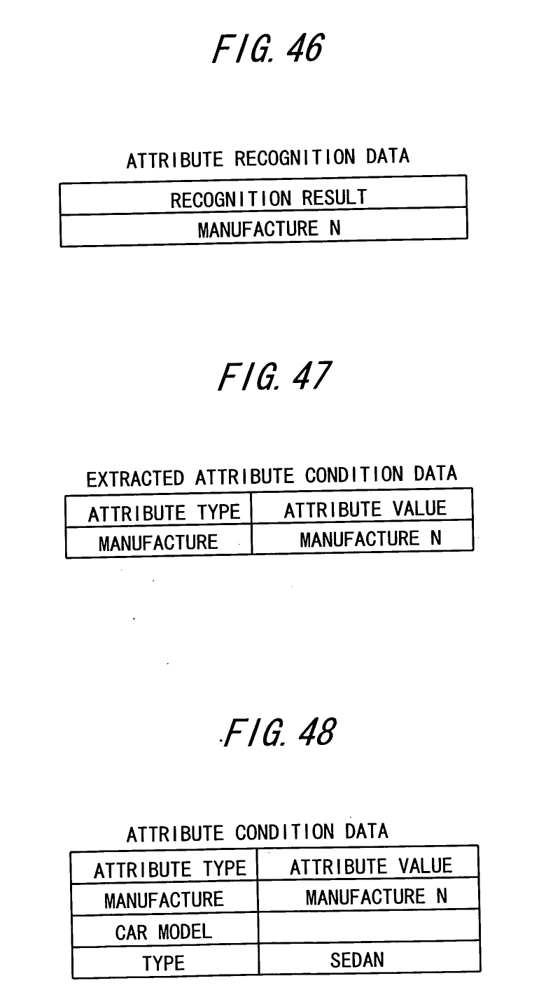

The car information provision application is realized by a portable information terminal such as a PDA (Personal Digital Assistance) reading and executing a predetermined program. The car information provision application finally selects one car (product) out of a large number of items of cars and displays information (detailed information) on the finally selected automobile as a product detail display screen (see FIG. 45).

(Schematic System Structure of the Car Information Provision Application)

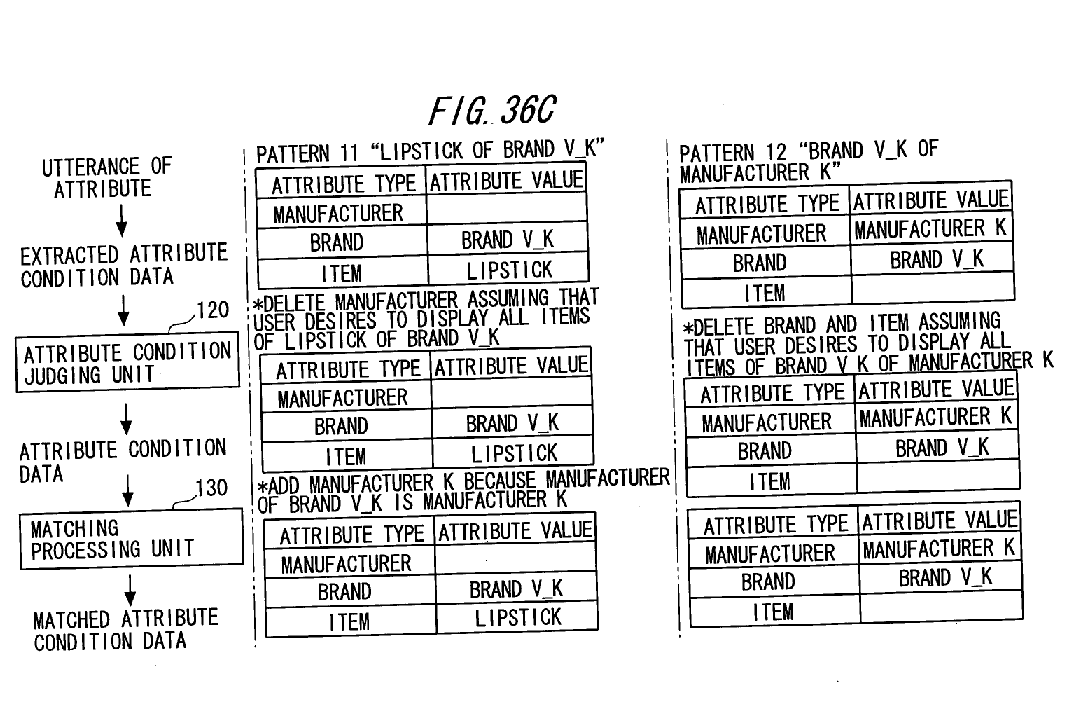

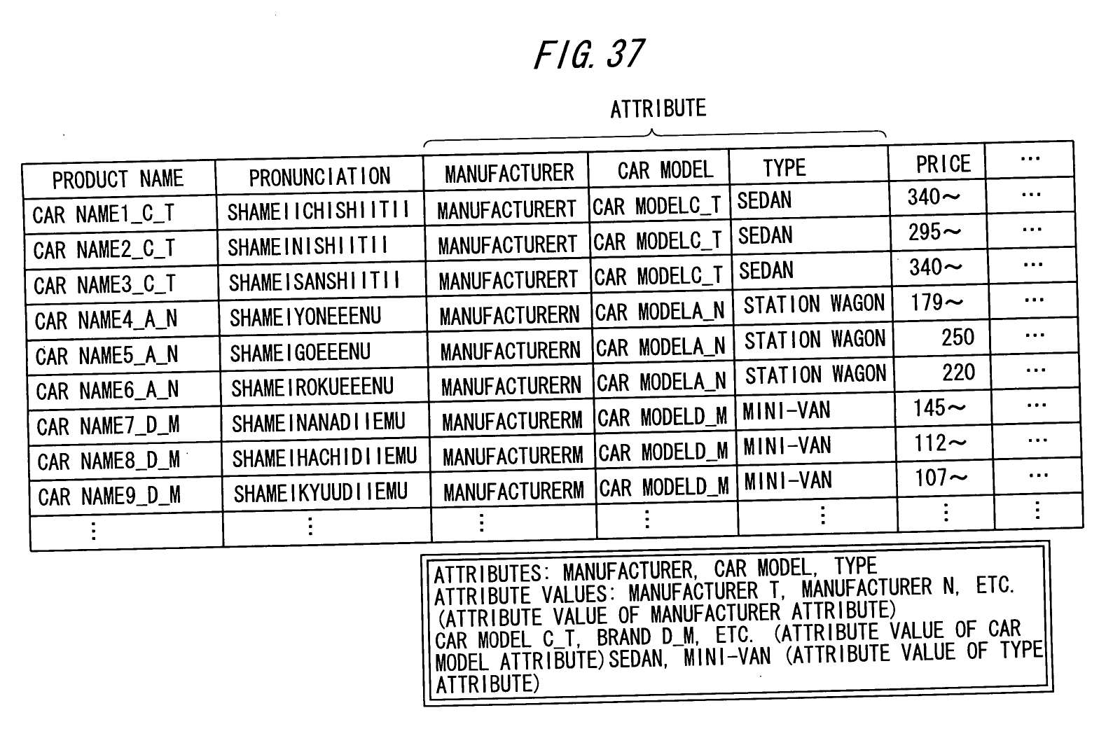

Product candidate data (candidate data of a large number of items of cars) is accumulated (stored) in the product candidate DB 200. FIG. 37 shows an example of the product candidate data. Data in one row in the figure indicates one product candidate data. The product candidate data is constituted by items (a product name, attributes (a manufacturer, a car model, and a type), a price, etc.) constituting the product detail display screen (see FIG. 45) and items (pronunciation, etc.) used as a recognition word by the voice recognition unit 110.

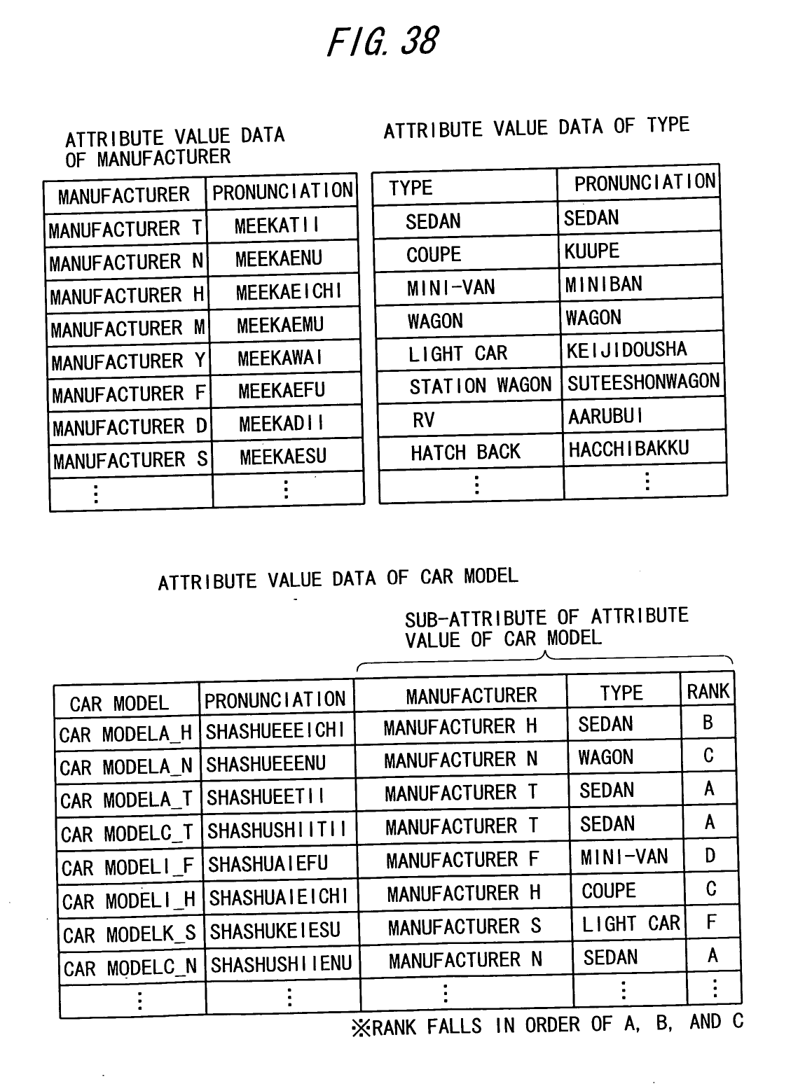

A correspondence relation between attribute values and pronunciations used as recognition words by the voice recognition unit 110 (attribute value data) is accumulated (stored) in the attribute value DB 210. FIG. 38 shows an example of the attribute value data. The attribute value data is provided for each of the attributes (the manufacturer, the car model, and the type). The attribute value data of the car model further includes a correspondence relation between the attribute values and sub-attributes thereof (a manufacturer, a type, and a rank) (see FIG. 38).

Since the other components are the same as those in the cosmetics information provision application, the components are denoted by identical reference numerals, and an explanation of the component will be omitted.

Next, an operation of the car information provision application (car information retrieval system) with the above-mentioned structure will be explained with reference to the drawings.

(Startup of the Car Information Provision Application)

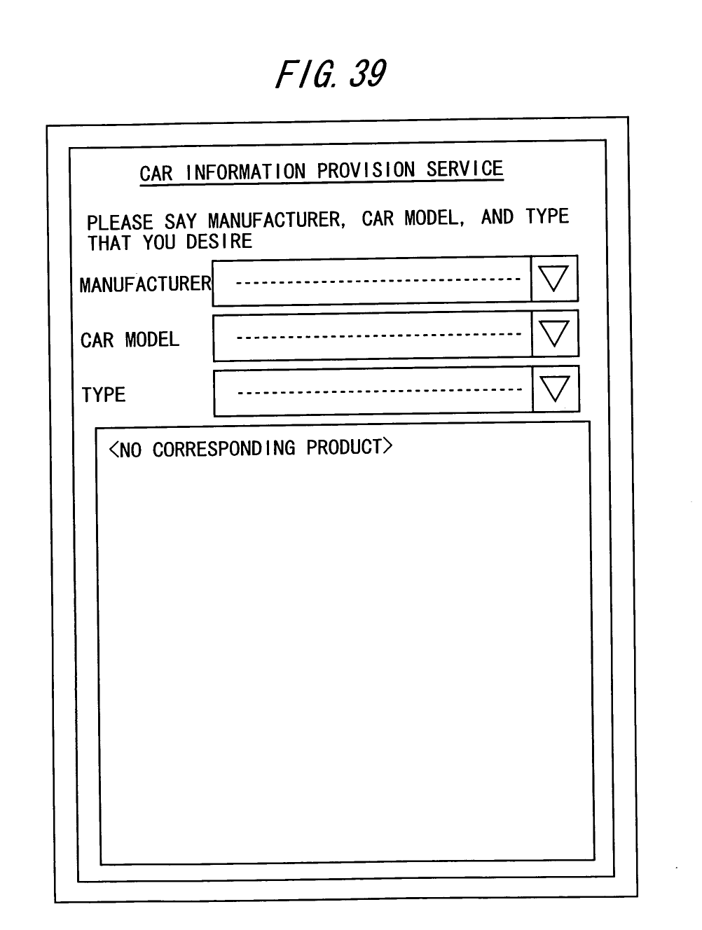

When a user starts the car information provision application, a product selection screen image is displayed (FIG. 39). This is the same as the processing up to displaying the product selection screen image (see FIG. 20) in the embodiment of the cosmetics information provision application (S100 to S104 in FIG. 18).

(Utterance)

The user, who has inspected the product selection screen image, utters a desired attribute value at the microphone 10. Here, it is assumed that the user has uttered “meekatii no shashushiitii (car model C_T of manufacturer T).”

(Voice Recognition of Attributes)

This is the same processing as the processing by the voice recognition unit 110 in the embodiment of the cosmetics information provision application (S107 to S109 in FIG. 18). Thus, the processing will be explained using the same reference numerals and signs.

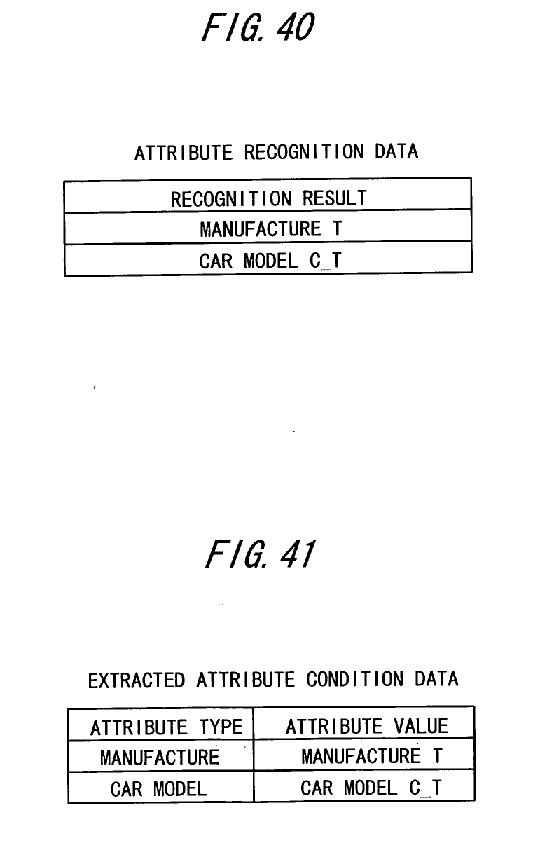

The voice recognition unit 110 applies publicly-known voice recognition (processing) to uttered contents (input voice data) of the user inputted via the microphone 10 to thereby recognize attribute values (here, (a manufacturer attribute value (a manufacturer T) and a car model attribute value (a car model C_T)) from the uttered contents of the user. FIG. 40 shows an example of a result of the recognition. The voice recognition unit 110 sends the recognition result (the manufacturer T and the car model C_T) to the application control unit 100 as attribute recognition data.

(Attribute Condition Judgment)

As shown in FIG. 18, upon receiving attribute recognition data (here, the manufacturer T and the car model C_T), the application control unit 100 creates a correspondence relation (extracted attribute condition data) between the respective attribute values (here, the manufacturer T and the car model C_T) constituting the received attribute recognition data and attributes (a manufacturer and a car model) (S107, S108). FIG. 41 shows an example of the extracted attribute condition data. The extracted attribute condition data is created by determining attributes corresponding to the respective attribute values with reference to the attribute value DB 210 (see FIG. 38) (S107, S108). The application control unit 100 sends the created extracted attribute recognition data (see FIG. 41) to the attribute condition judging unit 120 (S109).

Upon receiving the extracted attribute condition data, the attribute condition judging unit 120 creates retrieval conditions (attribute condition data) of the product candidate DB 200. If attribute condition data (also referred to as saved attribute condition data) used at the time when products were narrowed down (when products were retrieved) last time is registered in the saved attribute condition DB 230, the attribute condition data is created by taking into account the saved attribute condition data. This is the same processing as the processing by the attribute condition judging unit 120 in the embodiment of the cosmetics information provision application (S110 to S114 in FIG. 23). Thus, the processing will be explained using the same reference numerals and signs.

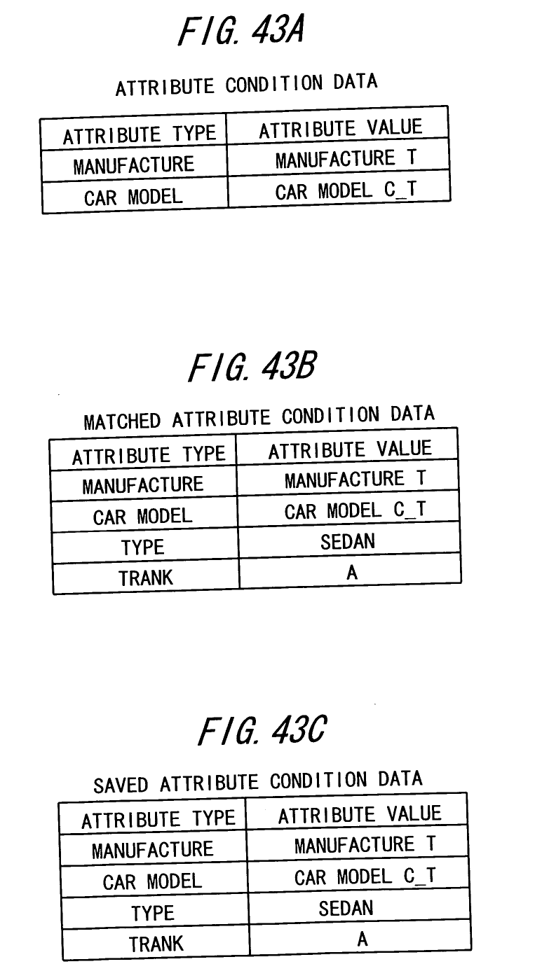

In order to create attribute condition data, first, the attribute condition judging unit 120 judges whether saved attribute condition data is registered in the saved attribute condition DB 230 (S110). Here, since the user has only uttered “meekatii no shashushiitii (the car model C_T of the manufacturer T)”, saved attribute condition data is not saved in the saved attribute condition DB 230. Therefore, the attribute condition judging unit 120 judges that saved attribute condition data is not registered (No in S110) and creates attribute condition data including the attribute values (the manufacturer T and the car model C_T) included in the extracted attribute condition data received earlier directly as attribute values (S113). FIG. 43 shows an example of the attribute condition data. The attribute condition judging unit 120 sends the created attribute condition data to the application control unit 100 (S114). Note that processing in the case where the attribute condition judging unit 120 judges that saved attribute condition data is registered (Yes in S110) as a result of the judgment in S110 (S111 to S114) will be further described later.

(Matching Processing)

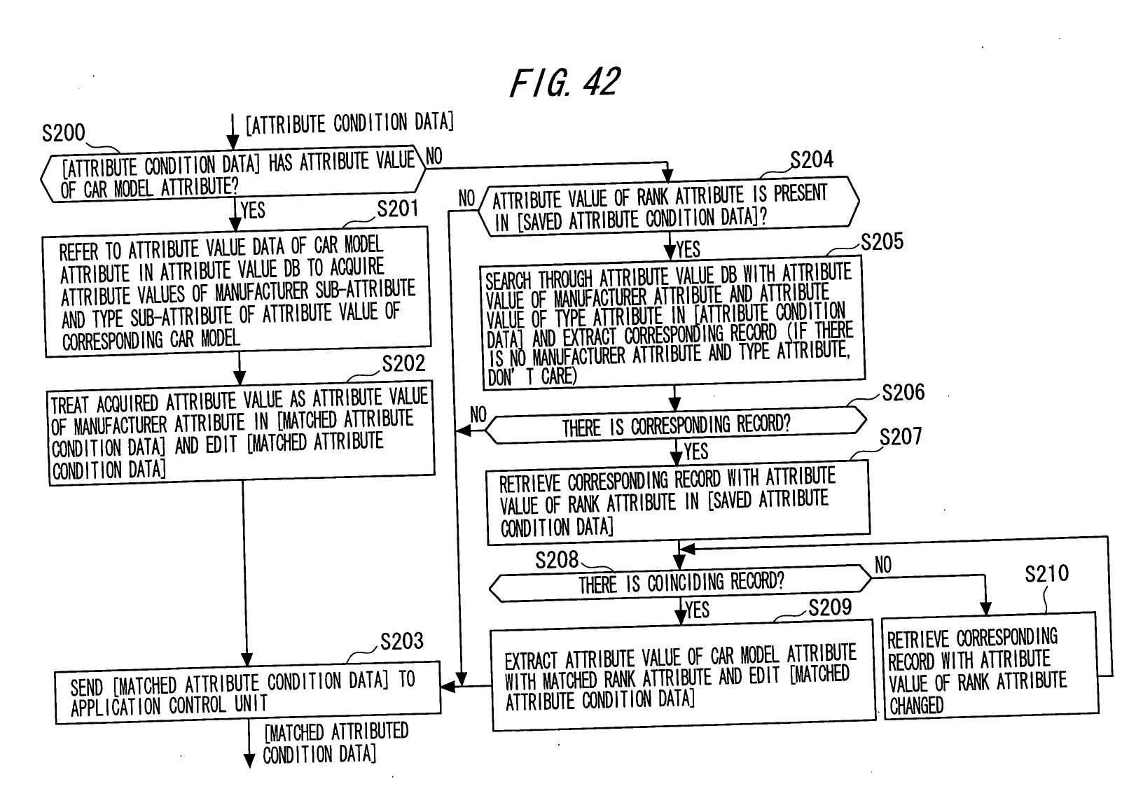

As shown in FIG. 15, upon receiving the attribute condition data from the attribute condition judging unit 120, the application control unit 100 sends the received attribute condition data to the matching processing unit 130. As shown in FIG. 42, upon receiving the attribute condition data, the matching processing unit 130 judges whether the received attribute condition data includes an attribute value of a car model attribute (S200). Here, since the attribute condition data has an attribute value (a car model C_T) of a car model attribute (Yes in S200), the matching processing unit 130 refers to the attribute value data of the car model attribute in the attribute value DB 210 (see FIG. 38) and acquires attribute values (a manufacturer T, sedan, and A) of a manufacturer sub-attribute, a type sub-attribute, and a rank sub-attribute of an attribute value of a car model corresponding to the attribute value (the car model C_T) of the car model attribute (S201). Then, the matching processing unit 130 edits the attribute condition data to thereby create matched attribute condition data including the acquired attribute values (the manufacturer T and sedan) (S202). FIG. 43B shows an example of the matched attribute condition data. Note that if the attribute condition data does not have an attribute value of a car model attribute, the matching processing unit 130 edits the attribute condition data based on a rank attribute in the saved attribute condition data.

When the matched attribute condition data is obtained as described above, the matching processing unit 130 sends the matched attribute condition data to the application control unit 100 (S203). In addition, the matching processing unit 130 creates saved attribute condition data obtained by adding the attribute value (A) of the rank sub-attribute acquired earlier to the matched attribute condition data and registers (saves) the saved attribute condition data in the saved attribute condition DB 230.

Upon receiving the matched attribute condition data from the matching processing unit 130, the application control unit 100 sends the received matched attribute condition data to the product candidate extracting unit 140.

(Extract Product Candidates)

This is the same processing as the processing by the product candidate extracting unit 140 in the embodiment of the cosmetics information provision application.

Upon receiving the matched attribute condition data, the product candidate extracting unit 140 acquires (reads out) product candidate data corresponding to the matched attribute condition data (FIG. 43B) from the product DB 200 (see FIG. 16) and sends the product candidate data to the application control unit 100. FIG. 37 shows an example of the product candidate data.

(Start Voice Recognition for a Product)

This is the same processing as the processing of S122 to S127 in the embodiment of the cosmetics information provision application. Thus, the processing will be explained using the same reference numerals and signs.

Upon receiving the product candidate data (see FIG. 37), the application control unit 100 creates a correspondence relation (product recognition word data) between product names and pronunciations used as recognition words by the voice recognition unit 110. Here, product recognition word data equivalent to the product recognition word data of FIG. 29 is created. The product recognition word data is created by extracting a product name part and a pronunciation part from the product candidate data received earlier. The application control unit 100 registers the created product recognition word data in the product recognition word DB 240 (S122).

When the registration is completed, the application control unit 100 sends a product recognition start message to the voice recognition unit 110 (S123). In addition, the application control unit 100 sends matched attribute condition data (see FIG. 43B) to the matched attribute condition display control unit 151 (S124). Moreover, the application control unit 100 sends the product candidate data (see FIG. 28) to the product list display control unit 152 (S125).

Upon receiving the product recognition start message, the voice recognition unit 110 starts voice recognition. The voice recognition is executed with the product recognition word data registered in the product recognition word DB 240 earlier as a recognition word. The voice recognition makes it possible to obtain a product name from uttered contents of the user.

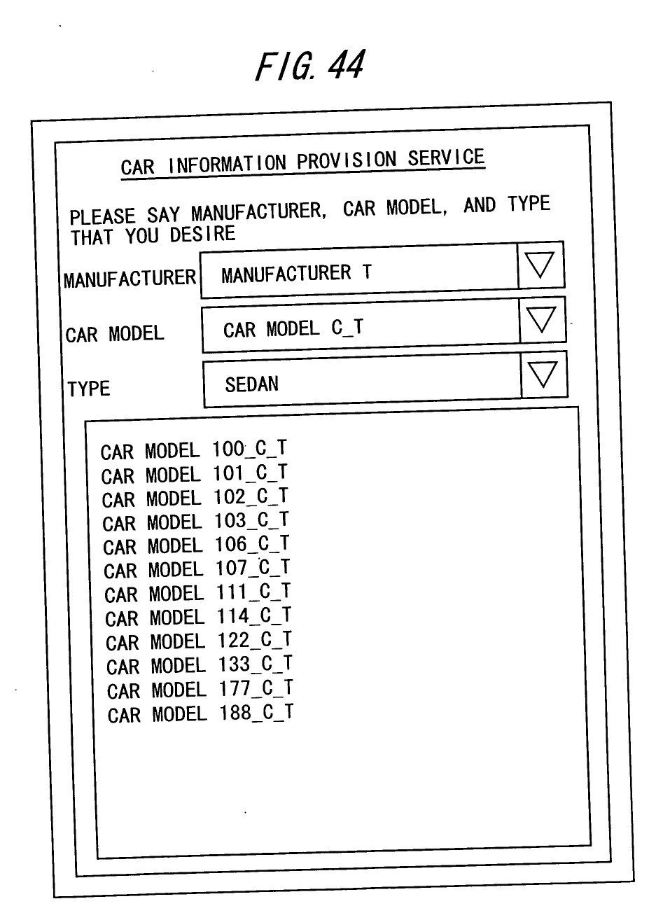

On the other hand, upon receiving the matched attribute condition data (see FIG. 43B), the attribute condition display control unit 151 instructs the product selection screen display unit 150 to display attributes. In addition, upon receiving the product candidate data, the product list display control unit 152 instructs the product selection screen display unit 150 to display products. As a result, a product selection screen image (see FIG. 44) is displayed on the display 20. The product selection screen image includes an indication facilitating the user to utter words (voice input) concerning a product name such as “shouhinmei wo osshattekudasai (please say a product name).”

(User, Utterance of a Product)

The user, who has inspected the product selection screen image, utters a desired product name at the microphone 10. Here, it is assumed that the user has uttered “shameinanajuunanashiitii (car name 77_C_T)” out of a product name list included in the product selection screen image.

(Voice Recognition for a Product)

The uttered contents (inputted voice data) of the user inputted via the microphone 10 are sent to the voice recognition unit 110 (S126). Upon receiving the inputted voice data, the voice recognition unit 110 applies publicly-known voice recognition (processing) to the inputted voice data. More specifically, the voice recognition unit 110 executes voice recognition with product recognition word data registered in the product recognition word DB 240 earlier as a recognition word.

Consequently, the voice recognition unit 110 recognizes a product name (here, the car name 77_C_T) from the uttered contents (here, the car name 77_C_T) of the user. The voice recognition unit 110 sends a result of the recognition (the car name 77_C_T) to the application control unit 100 as product recognition data (S127).

(Provision of Information on a Product)

Upon receiving the product recognition data (the car name 77_C_T), the application control unit 100 creates product candidate data corresponding to the received product recognition data. The product candidate data is created by extracting product candidates corresponding to the product recognition data received earlier from the product candidate data (e.g., product candidate data received from the product candidate extracting unit 140). The application control unit 100 sends the created product candidate data to the product detail display unit 160.

Upon receiving the product candidate data, the product detail display unit 160 displays on the display 20 a product detail display screen image (see FIG. 45) including information (detailed information such as a product name in the product candidate data received earlier) on the product finally selected by the user (here, the car name 77_C_T).

(Retrieve a Product by Changing Attribute Conditions)

When the user presses a button “return to the previous screen” displayed on the product detail display screen image (see FIG. 45), the product detail display unit 160 sends a screen close message to the application control unit 100 and, at the same time, closes the product detail display screen. Upon receiving the screen close message, the application control unit 100 sends an attribute recognition start message to the voice recognition unit 110. A product selection screen image (see FIG. 44) is displayed on the display 20.

Next, under this situation, it is assumed that the user has further uttered an attribute. In this case, from the viewpoint of narrowing down data efficiently, matched attribute condition data is created by estimating an intention included in uttered contents of the user. The processing will be explained with reference to the drawings.

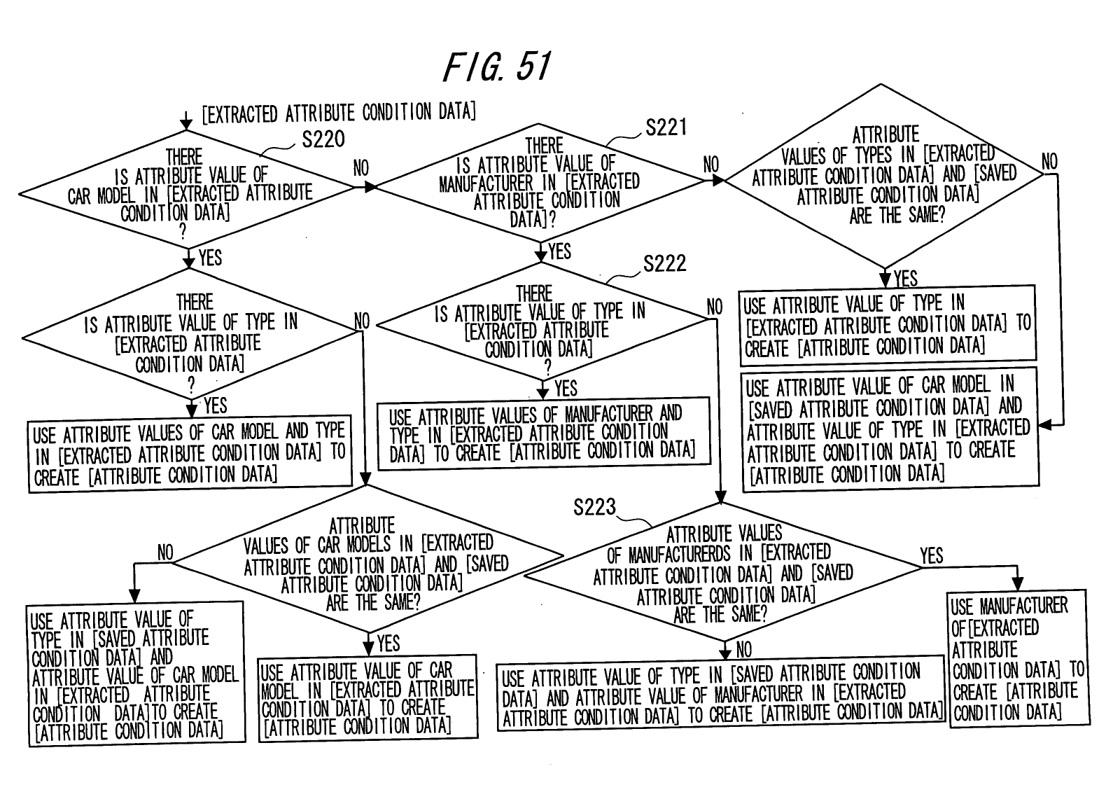

Here, extracted attribute condition data, attribute condition data, and matched attribute condition data, which are created in the state in which the user has uttered an attribute value (here, a manufacturer N) of a manufacturer different from that in uttered contents of the last time under a situation in which attribute conditions (here, saved attribute condition data shown in FIG. 43C) obtained from the uttered contents of the last time are registered in the saved attribute condition DB 230, will be explained. Note that, although only one pattern is introduced here, the same patterns as those in the embodiment of the cosmetics information provision application are also possible (see. FIG. 51).

(Extracted Attribute Condition Data)

This is created by the same processing as the processing of S107 to S109 in the embodiment of the cosmetics information provision application. FIG. 47 shows an example of extracted attribute condition data obtained by the processing.

(Attribute Condition Data)

This is created by the same processing as the processing of S110 to S114 in FIG. 23 in the embodiment of the cosmetics information provision application. Thus, the processing will be explained using the same reference numerals and signs.

More specifically, as shown in FIG. 23, first, it is judged whether saved attribute condition data (see FIG. 27) is registered in the saved attribute condition DB 230 (S110). Here, saved attribute condition data is saved in the saved attribute condition DB 230. Therefore, it is judged that the saved attribute condition data is registered (Yes in S110), the registered saved attribute condition data is acquired from the saved attribute condition DB 230 (S111), attribute setting processing for estimating an intention of an uttering person is performed (S112), and attribute condition data (see FIG. 48) is created (S113).

(Attribute Setting Processing)

Next, the attribute setting processing in S112 will be explained with reference to FIG. 51.

First, it is judged whether there is a car model attribute in the extracted attribute condition data (S220). Since there is no car model attribute in the extracted attribute condition data (see FIG. 47), it is judged that there is no car model attribute (No in S220), and it is further judged whether there is a manufacturer attribute value in the extracted attribute condition data (S221). Since there is a manufacturer attribute value in the extracted attribute condition data, it is judged that there is a manufacturer attribute value (Yes in S221), and it is further judged whether there is a type attribute in the extracted attribute condition data (S222). Since there is no type attribute in the extracted attribute condition data (see FIG. 47), it is judged that there is no type attribute (No in S222), and it is further judged whether the manufacturer attributes in the extracted attribute condition data and the saved attribute condition data are the same (S223). Here, since attribute values in both the manufacturer attributes are different, it is judged that the manufacturer attributes are not the same (No in S223). In this case, attribute condition data including the type attribute value (here, sedan) in the saved attribute condition data acquired earlier and the manufacturer attribute value (here, the manufacturer N) in the extracted attribute condition data is created (S224).

This means that it is assumed that, in the case where the uttered contents of this time include only a manufacturer attribute value different from that in the uttered contents of the last time, the user (uttering person) has an intention of (1) using the manufacturer attribute value (here, the manufacturer N) included in the uttered contents of this time for the attribute condition data of this time, (2) not using the car model attribute value (here, the car model C_T) included in the uttered contents of the last time for the attribute condition data of this time (deleting the car model attribute value), and (3) continuously using the type attribute value (here, the sedan) included in the uttered contents of the last time for the attribute condition data of this time.

(Matched Attribute Condition Data)

Next, matching processing will be explained with reference to FIG. 42.

First, it is judged whether attribute condition data has an attribute value of a car model attribute (S200). Here, since the attribute condition data created earlier does not have an attribute value of a car model attribute (No in S200), an attribute value (here, A) of a rank attribute in the saved attribute condition data (see FIG. 43C) is referred to, and the rank attribute (A) is obtained (Yes in S204).

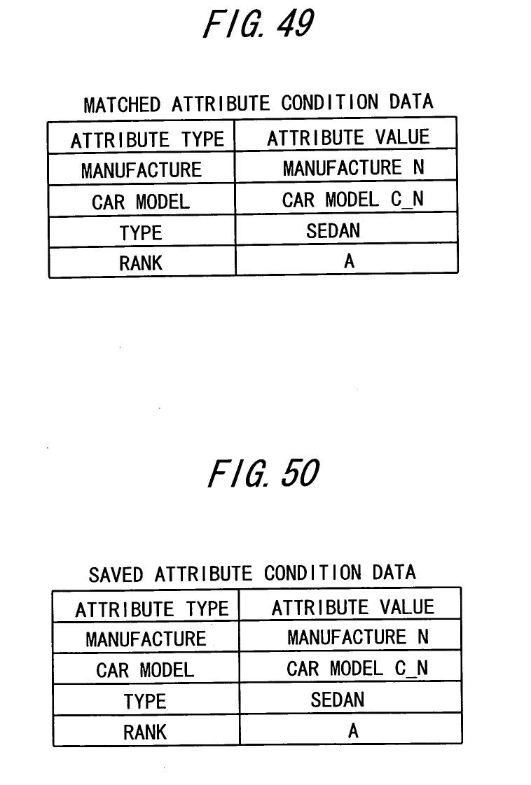

Next, attribute value data of a car model in the attribute value DB 210 is retrieved with conditions of attribute values of a manufacturer and a car model (a manufacturer N and sedan) in the attribute condition data (S205). If a result of the retrieval is obtained (Yes in S206), a car model attribute value (here, a car model C_N), which coincides with the rank attribute (A) obtained earlier, is extracted from the retrieval result (S207). If there is a car model attribute value with a coinciding rank sub-attribute (Yes in S208), an attribute value of the car model attribute with the coinciding rank attribute is extracted to edit consistent condition data (S209). In this way, by editing the attribute condition data, in the matched attribute condition data, a manufacturer attribute, a car model attribute, and a type attribute are the manufacturer N, C_N, and sedan as shown in FIG. 49. The matching processing unit 130 sends the matched attribute condition data to the application control unit 100. In addition, the matching processing unit 130 extracts an attribute value (A) of a rank sub-attribute and registers (saves) the attribute value (A) in the saved attribute condition DB 230 as saved attribute condition data shown in FIG. 50 together with the matched attribute condition data.

On the other hand, if there is no car model attribute value with a coinciding rank sub-attribute (No in S208), a car model attribute value with a closest rank sub-attribute is extracted (S209).

Next, the product candidate DB 200 is searched through based on the matched attribute condition data, a list of products is displayed, and detailed information on selected products is performed. Since this is the same processing as the processing in the embodiment of the cosmetics information provision application, an explanation of the processing will be omitted.

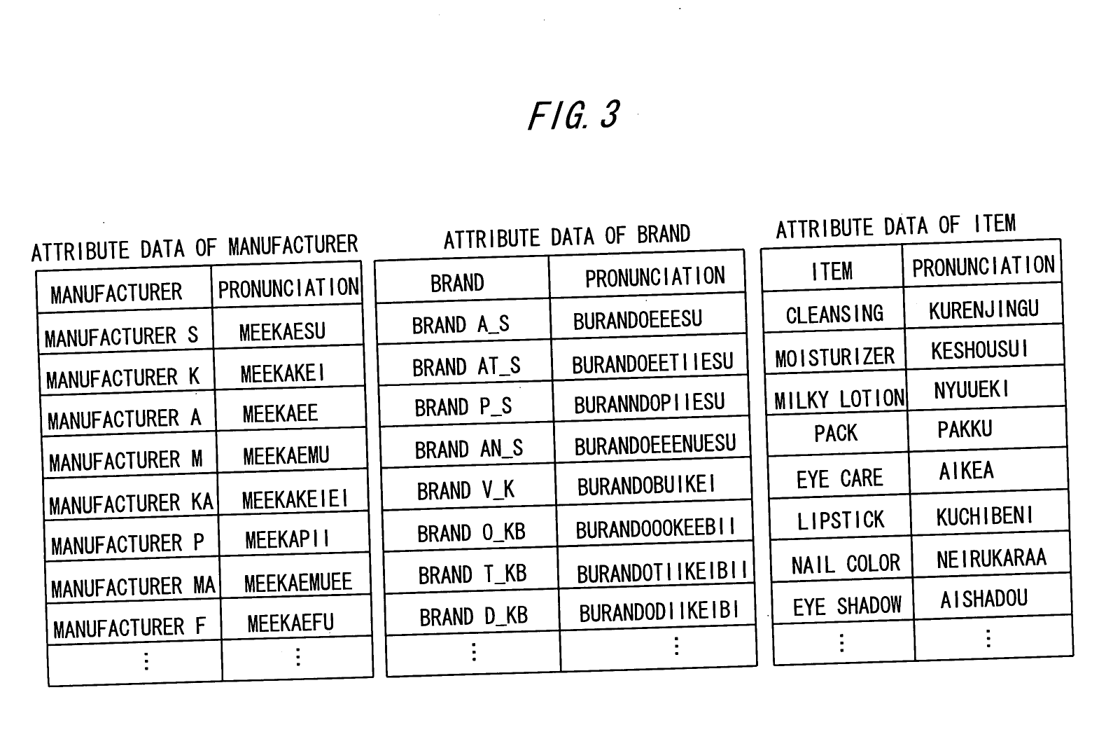

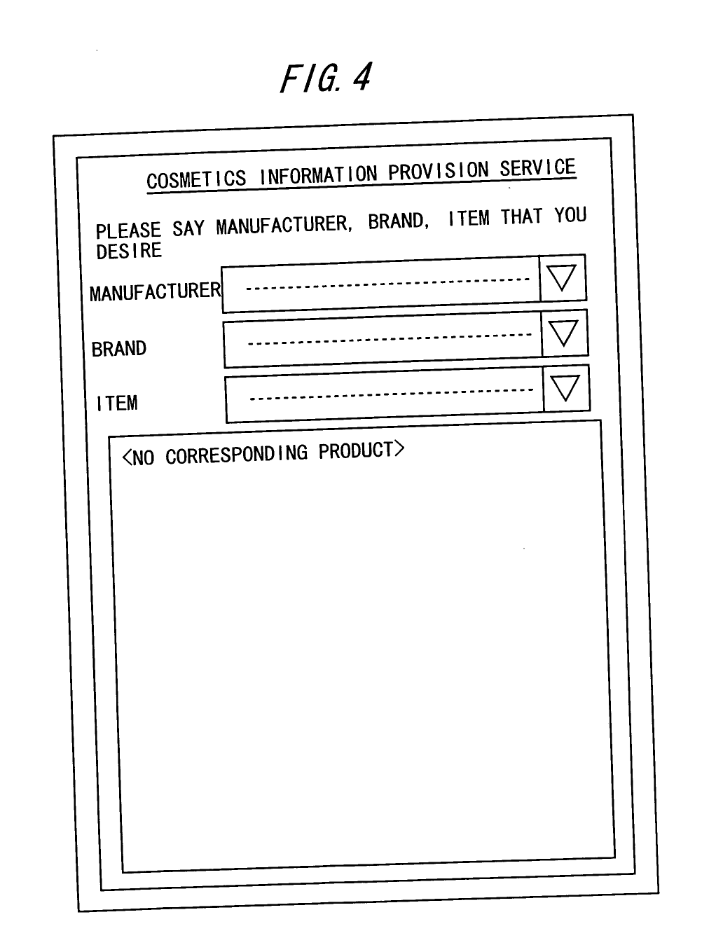

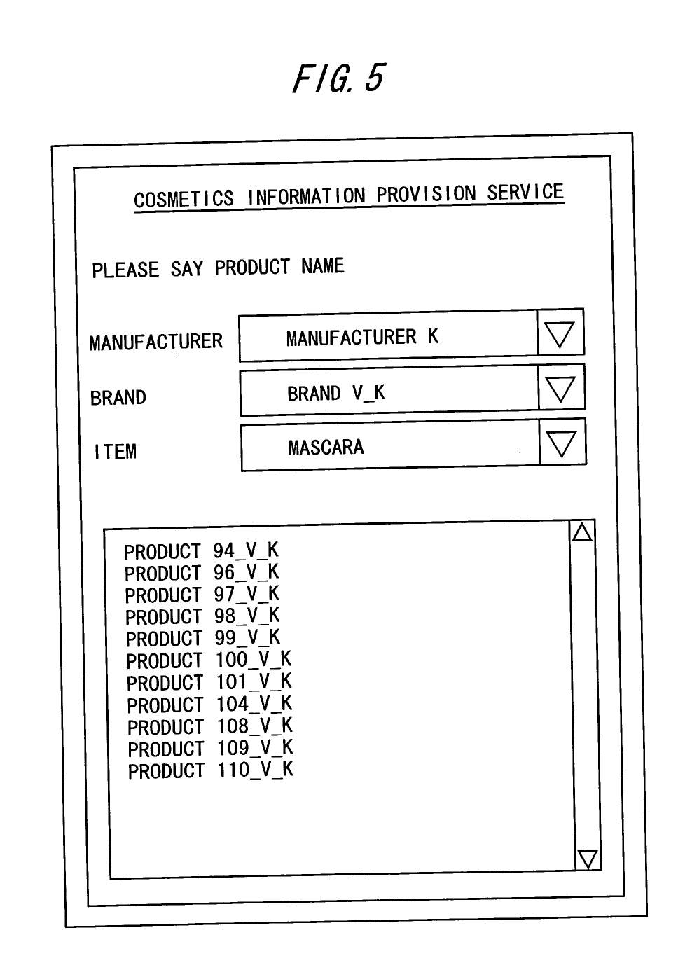

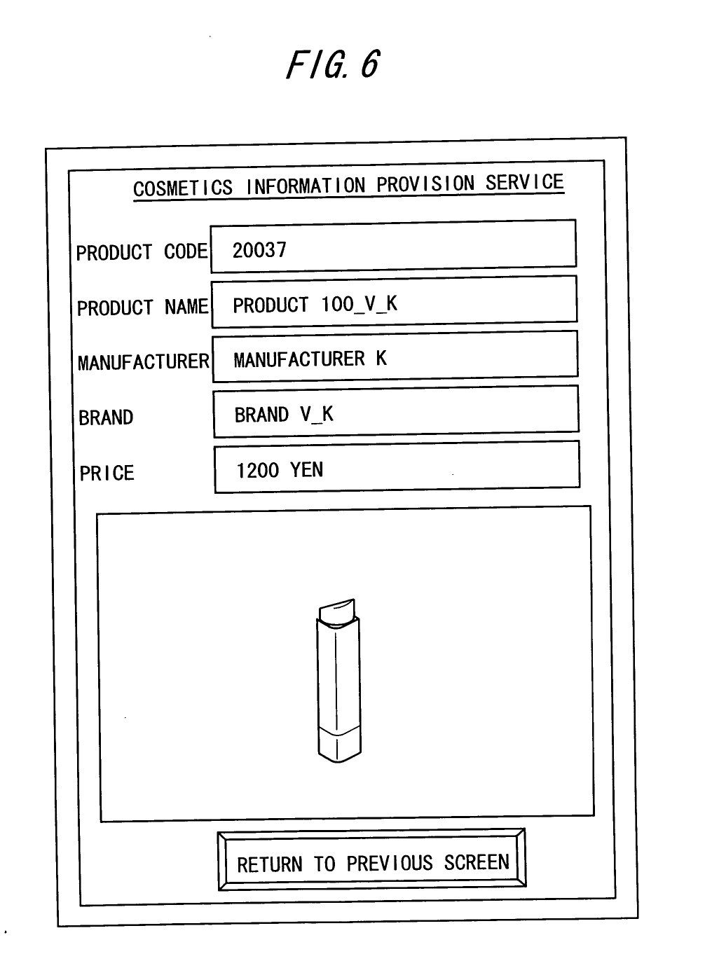

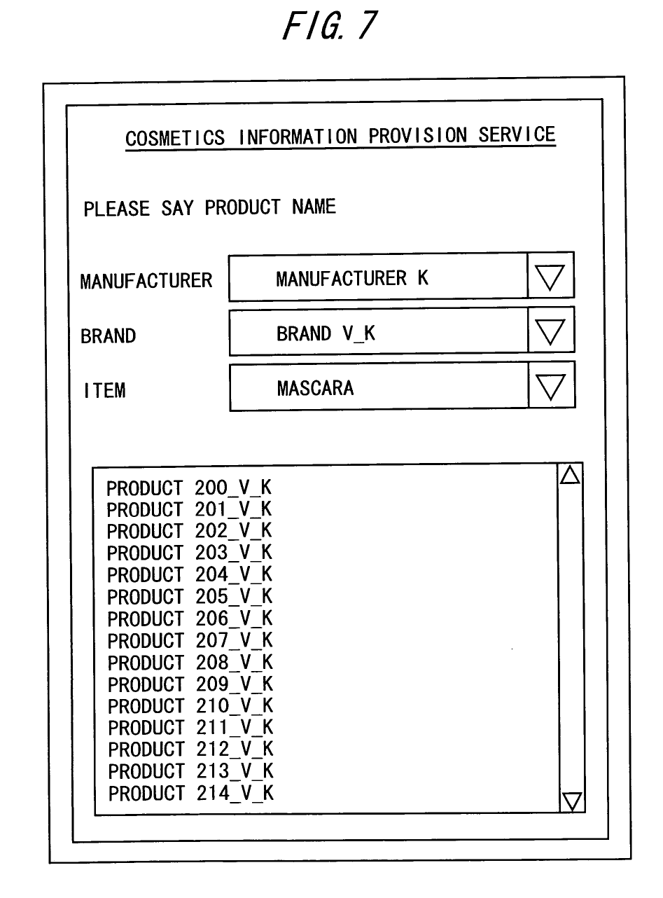

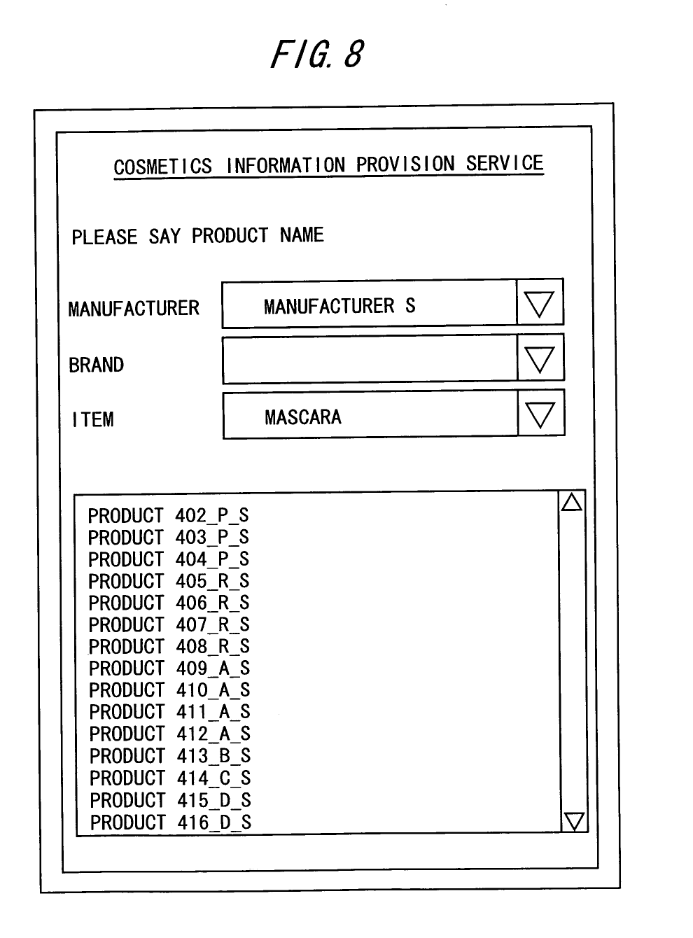

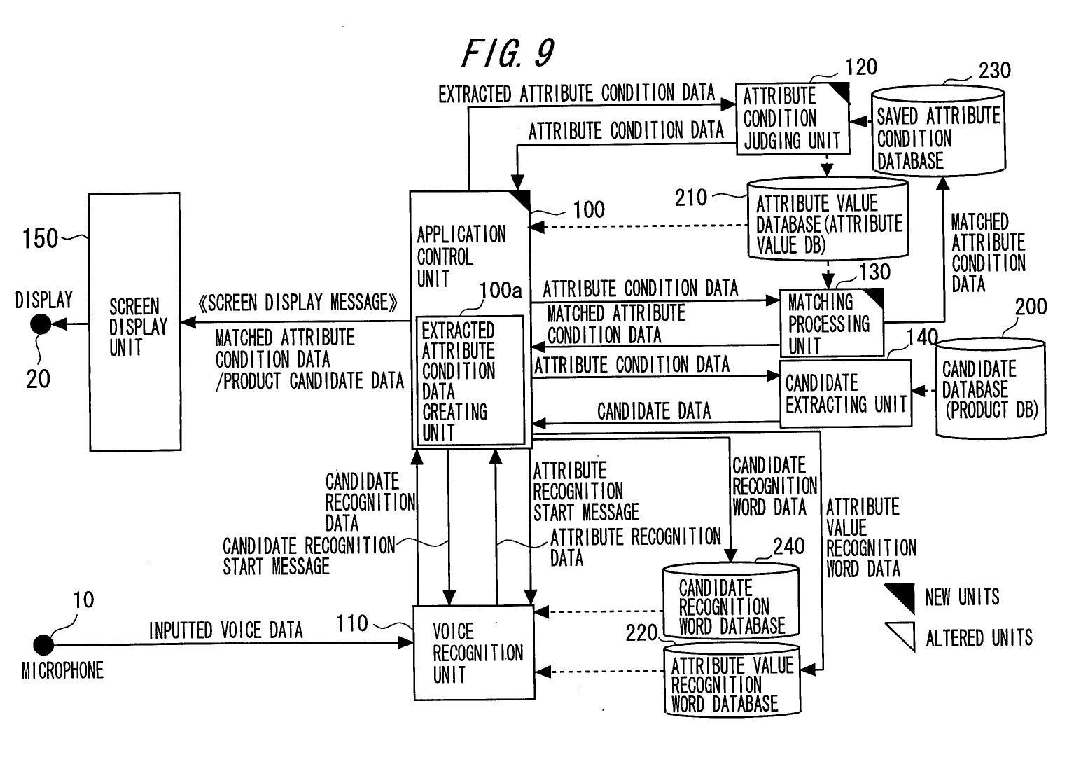

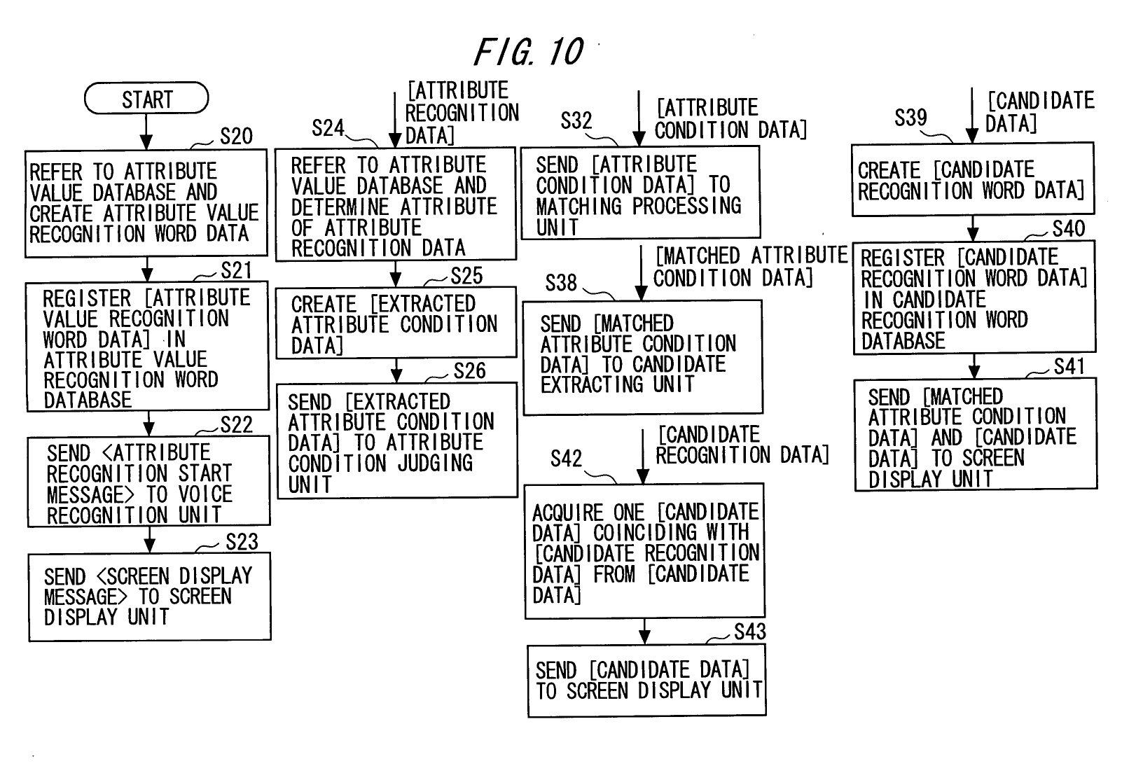

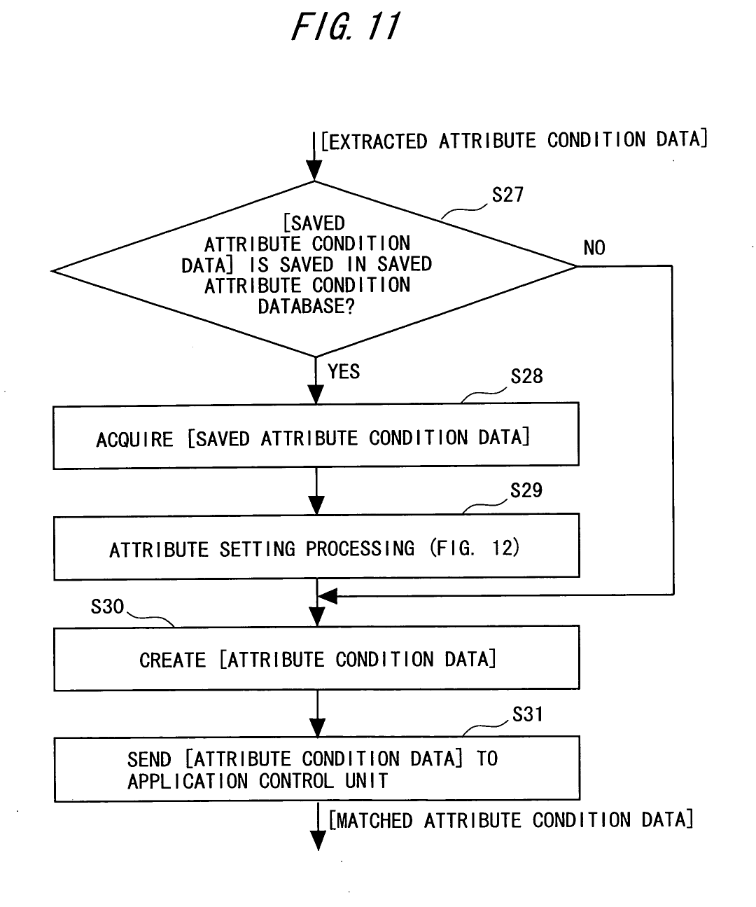

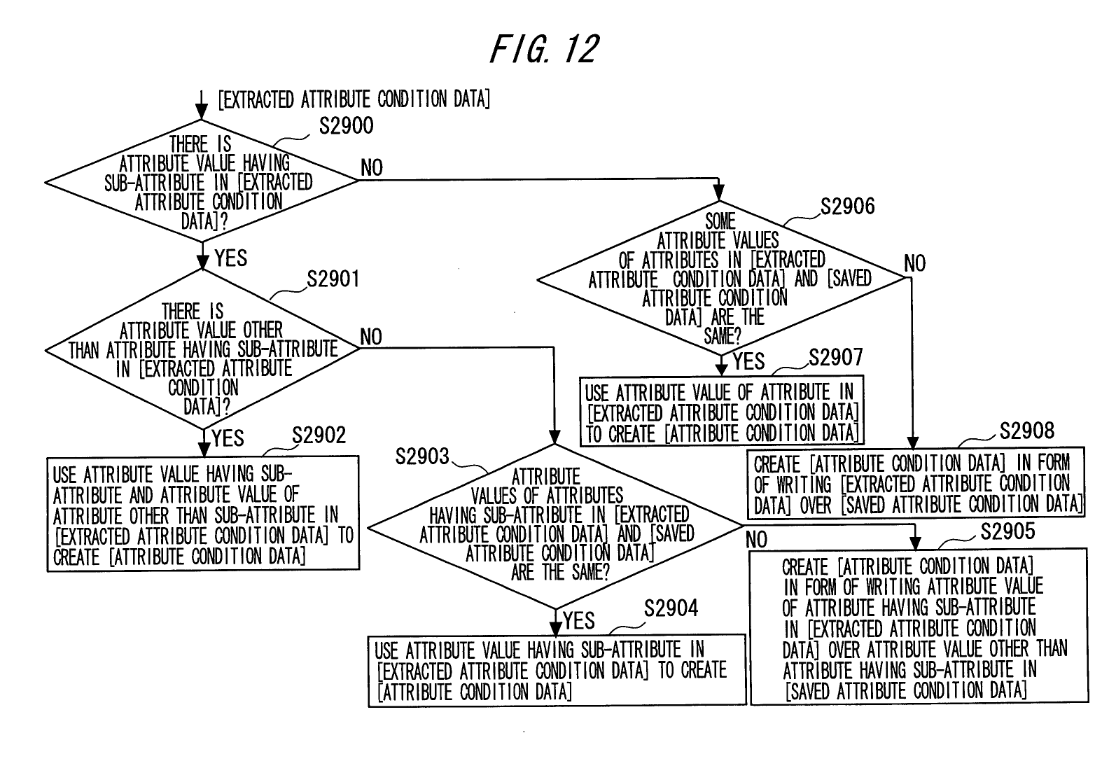

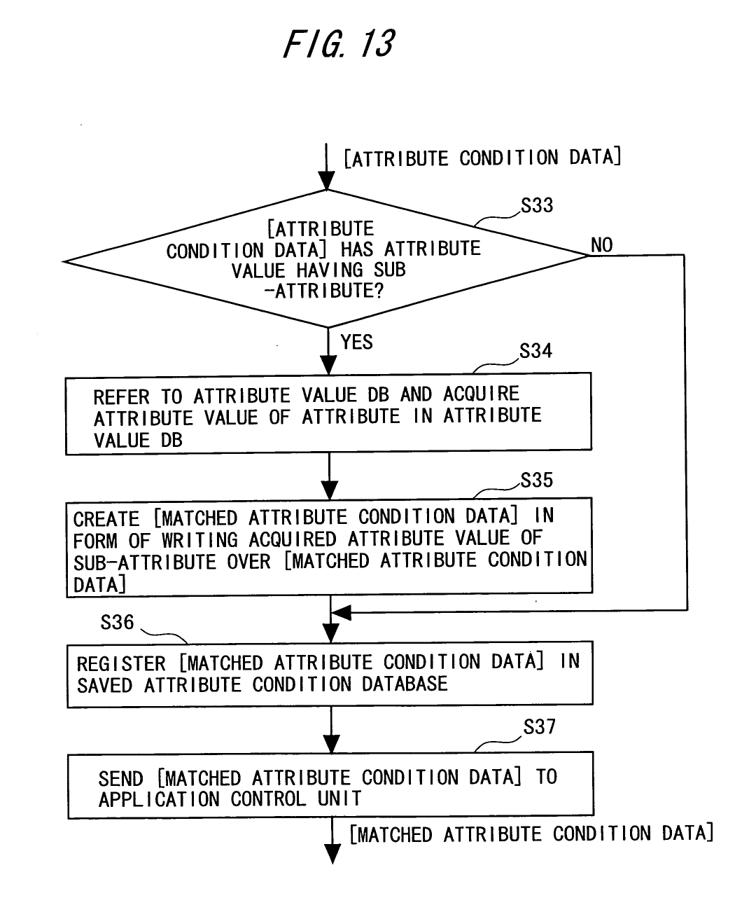

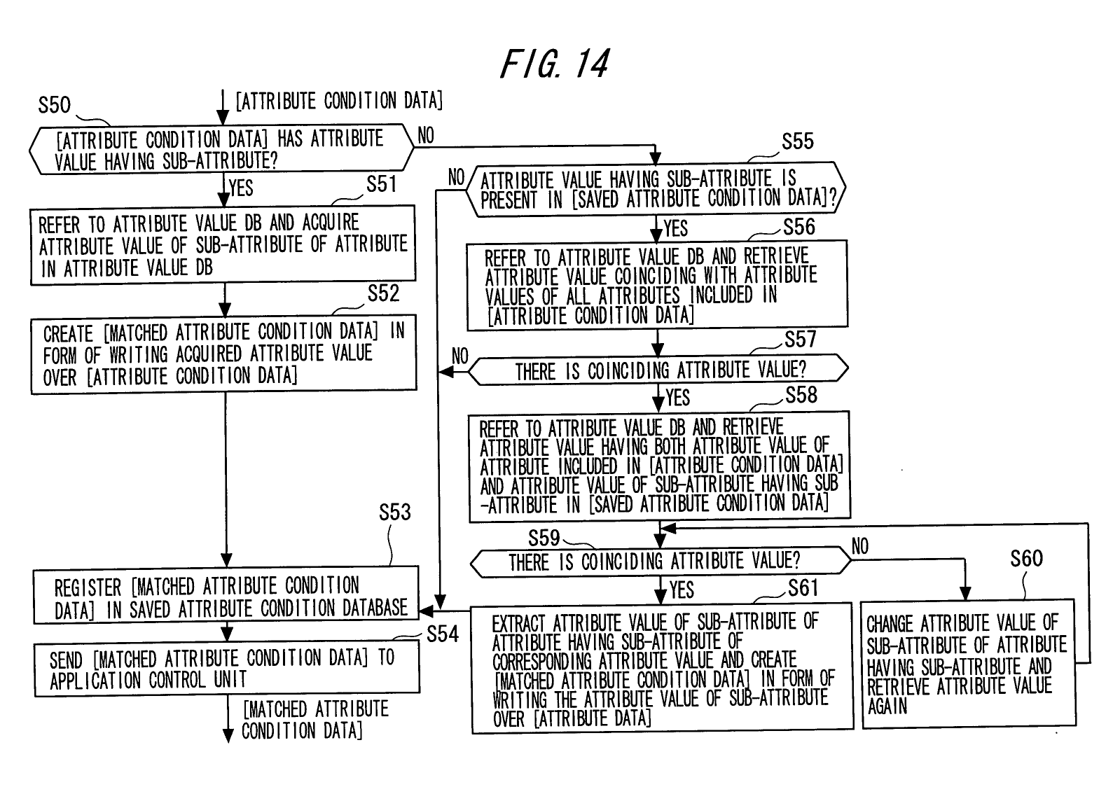

Note that, in the embodiment, for example, as shown in FIG. 3, “kurenjingu” or the like read in the Roman letters are set as a pronunciation for the item “cleansing” or the like. This is because the system is constituted on the premise that voice recognition is performed with respect to utterance of the Japanese.

Therefore, if the system is constituted on the premise that voice recognition is performed with respect to utterance of the Europeans and the Americans, “cleansing” read in the English letters only has to be set as a pronunciation for the item “cleansing”. Note that the same holds true for pronunciations other than “kurenjingu” shown in FIG. 3 and the like.

The embodiments are only examples in every respect. Therefore, the invention should not be interpreted as being limited to the embodiment. In other words, the invention can be carried in various forms without departing from the spirit and main characteristics thereof.

According to the invention, an attribute value, which a user desires to select, is estimated based on extracted attribute condition data including attribute values obtained from uttered contents (voice input of the user and saved attribute condition data, which is setting information of attribute values of the last time, to create attribute condition data to be used for retrieval of this time.

Therefore, an attribute, which the user desires to set, can be set without causing the user to utter an unnecessary attribute value such as “burando wo kuria (clear the brand.” and without causing the user to input contents uttered last time again by voice.

Thus, it is possible to cause the user to perform setting of an attribute value which saves the user trouble and time and which is convenient.

In addition, for attributes in a dependence relation such as a manufacturer and a brand of cosmetics, consistency can be taken automatically.

Thus, a situation can be eliminated, in which consistency of attribute values, which a user is about to set, is not taken and candidates are not narrowed down.

Therefore, the user can use the voice input service comfortably.

Further, when a manufacturer T and a car model C_T are set as attributes last time, and a user utters “meekaenu (manufacturer N.” next, car models in the same rank as the car model C_T of the manufacturer T can be extracted out of car models of a manufacturer N.

This allows the user to inspect information on car models in the same rank even if the user does not know the car models of the manufacturer N.

Thus, serviceability can be improved.

1. A system that performs retrieval according to attribute conditions uttered by a user, including:
a microphone through which the user performs voice input;
a voice recognition unit recognizing an attribute value from inputted voice data inputted via the microphone;
an extracted attribute condition data creating unit creating extracted attribute condition data that is a correspondence relation between an attribute value recognized by the voice recognizing unit and an attribute;
a saved attribute condition database in which saved attribute condition data, which is attribute conditions used for retrieval of the last time, is saved;
an attribute condition judging unit creating attribute condition data, which is used for retrieval of this time, based on the extracted attribute condition data and the saved attribute condition data;
a candidate database storing candidate data to be an object of retrieval;
a candidate extracting unit retrieving candidate data from the candidate database based on the attribute condition data; and
a display displaying a screen including a result of the retrieval.

2. A voice retrieval system according to claim 1, further including a matching processing unit saving the attribute condition data in the saved attribute condition database.

3. A voice retrieval system according to claim 1, in which the attribute condition judging unit estimates an intention of the user to thereby judge whether the attribute conditions used for the retrieval of the last time are used continuously or cancelled and creates the attribute condition data to be used for the retrieval of this time.

4. A voice retrieval system according to claim 2, in which in the case where the attribute condition data includes a sub-attribute, the matching processing unit complements other attribute conditions with the sub-attribute.

5. A voice retrieval system according to claim 1 or 4, in which the matching processing unit includes a function for, in the case where the attribute condition data includes a sub-attribute, saving the sub-attribute in the saved attribute condition database, extracting uninputted attribute conditions which coincide with the attribute condition data and which the sub-attribute saved in the saved attribute condition database coincides with or is approximate to, and adding the attribute conditions.

6. A system that extracts an attribute value from inputted voices, which was inputted by a user via a microphone, creates retrieval conditions including the attribute value, and performs retrieval according to the retrieval conditions, including:
a unit, in the case where a user performs voice input via a microphone after the retrieval, extracting an attribute value from the inputted voices;
a unit creating new retrieval conditions based on the attribute value and the retrieval conditions; and
a unit performing retrieval with the new retrieval conditions.

7. A method of extracting an attribute value from inputted voices, which was inputted by a user via a microphone, creating retrieval conditions including the attribute value, and performing retrieval according to the retrieval conditions, the method including the steps of:
in the case where a user performs voice input via a microphone after the retrieval, extracting an attribute value from the inputted voices;
creating new retrieval conditions based on the attribute value and the retrieval conditions; and
performing retrieval with the new retrieval conditions.
